(19) United States
(12) Patent Application Publication
(10) Pub. No.: US 2003/0084277 A1
(43) Pub. Date: May 1, 2003

(54) User configurable audio CODEC with hot swappable audio/data communications gateway having audio streaming capability over a network

(76) Inventors: Dennis Przywara, Shrewsbury, NJ (US); Stephen Arleth, Howell, NJ (US)

Correspondence Address: TODD L. JUNEAU, NATH & ASSOCIATES, SIXTH FLOOR, 1030 15TH STREET N.W., WASHINGTON, DC, 20005, US

(21) Appl. No.: 10/188,998

(22) Filed: Jul. 5, 2002

Related U.S. Application Data
(60) Provisional application No. 60/303,043, filed on Jul. 6, 2001.
(60) Provisional application No. 60/315,028, filed on Aug. 28, 2001.

(51) Int. Cl. G06F 9/00; G06F 15/16

(52) U.S. Cl. 713/1; 709/200

(57) ABSTRACT

An audio/data gateway having a DSP-based platform provides a link between broadcast audio, communications and information technology. Configurable hardware and software interfaces enable configuring as a CODEC, linear STL, and network audio server with multi-format streaming. Remote audio can be fed directly to a network, or over the STL with built-in ISDN backup. Optional hot-swappable plug-in modules are recognized by a control processor that stores all operating software and downloads it as each module is inserted displaying its functions as menu choices. A menu window with hot keys guides a user through programming. Two separate stereo feeds, or four mono feeds can be transmitted over T1, E1, multiple ISDN BRIs or dedicated data circuits. Multiple streaming formats permit direct network feeds. Password-protected remote control access via the network is supported from any Web browser. The device has an alphanumeric keypad, navigation wheel, programmable function keys, dual-channel VU meter and headphone connector.

### FIELD OF THE INVENTION

The present invention relates generally to an audio CODEC with an integrated audio/data communications gateway; and pertains, more particularly, to an audio CODEC with audio/data communications gateway having audio streaming capability over a network. The audio CODEC with audio/data communications gateway of the present invention is adapted to accept hot-swappable circuit option cards and to recognize the installed circuit option cards; and has an embedded, upgradable, downloadable, software programming configuration routine that guides a user, on an integral, user-friendly, programming interface, through configuration sub-routines corresponding to the installed circuit option cards.

### BACKGROUND OF THE INVENTION

Current technology permits the translation of analog audio signals into a sequence of binary numbers (digital). These numbers may then be transmitted and received through a variety of means. The received signals may then be converted back into analog audio signals. The device for performing both the conversion from analog to digital and the conversion from digital to analog is called a CODEC. This is an acronym for COder/DECoder.

The cost of transmitting digital information from one location to another is a function of the data transfer rate. The data transfer rate is governed by the speed at which selected transmission facility can transmit data and the bandwidth of the transmission facility. Generally speaking, the higher the data transfer rate the higher the cost. Certain laws of physics in human and audio perception establish a direct relationship between perceived audio quality and the data transfer rate with the net result being that improved audio quality increases the cost of transmission.

CODEC manufacturers have developed technologies (encoding techniques, including compression) to reduce the number of digital data bits required to transmit a given audio signal thereby reducing the associated transmission costs. The cost of transmission of data is also a function of the transmission facility used, i.e., satellite, PCM phone lines, or TSDN (fiber optics).

A CODEC that contains some of these compression techniques also acts as a computing device. The CODEC receives an analog audio input signal, converts the audio signal to a digital bit stream, and then applies a selected compression technique to the bit stream in order to reduce the number of data bits required to successfully transmit a perceptible portion of the original audio signal. A receiving CODEC applies in reverse a similar compression technique (decoding) to convert the compressed digital bit stream back into a decompressed bit stream. The decompressed bit stream is then converted back to the perceptible portion of the original analog audio input signal. The difference in quality between the analog audio input and the reconstructed audio output is an indication of the quality of the compression technique.

Currently, the most successful compression techniques are perceptual coding techniques. These compression techniques selectively discard unperceivable components of the audio signal based on the auditory characteristics of the human ear and interpretive capabilities of the human brain. For example, if a very loud sound (relatively large amplitude) occurs simultaneously with a softer sound (relatively small amplitude), and depending on the relative frequency of the two sounds in the audio spectrum (which ranges from about 20 Hz to about 20 kHz), the human ear will generally only recognize the louder sound. As a result, compression techniques can effectively ignore the softer sound and not assign any data bits to its transmission and reproduction under the assumption that a human listener would not perceive the softer sound even if it were faithfully transmitted and reproduced.

Many conventional CODECs use perceptual coding techniques which utilize a basic set of parameters which define their behavior. For example, the coding technique must determine how soft a sound must be relative to a louder sound in order to make the softer sound a candidate for exclusion from transmission. A number which determines this threshold is considered a parameter of the scheme which is based on that threshold. These parameters are largely based on the human psychology of perception so they are collectively known as psycho-acoustic parameters.

Advanced CODECs, such as those disclosed by U.S. Pat. Nos. 6,301,555 and 6,041,295, incorporated herein by reference in their entirety, and assigned to the assignee of the instant application, allow the user to adjust psycho-acoustic parameters of the encoding-compression/decoding-decompression algorithms. Knobs or keypads on the face of a CODEC allow a user to modify and control the value of the psycho-acoustic parameters and to observe (hear) the results of the parameter modifications in real time by listening to an output audio signal.

The CDQPrima™ line of advanced audio stereo CODECs by the assignee of the instant application are digital audio CODECs with selectable compression/decompression routines having user adjustable psycho-acoustic parameters. The CODECs can be programmed to: dial on audio and hang up on silence; provide automatic studio-to-transmitter (STL) backup; automatic call configuration; automatic algorithm detection; and automatic remote control of, and by, external devices. Various plug-in interface modules allow direct connection to a digital transmission system such as an Integrated Services Digital Network (ISDN); or with available V.35, X.21 or RS422A interfaces. Two independent audio channels can be sent to two or more locations; or the same monaural or stereo program can be sent to as many as six locations simultaneously. Near and far-end remote control can be achieved using an attached terminal or personal computer (PC). Slots are provided for optional network interface cards. A user interacting through the remote terminal or PC invokes a set-up routine to configure the CODEC's operating parameters to best suit the user's particularized application.

The TEAM™ multiplexing CODEC/transmission system by the assignee of the instant application provides an advanced audio CODEC with hot swap capabilities for audio and data interface modules; and can be connected to T1 or E1 transmission lines. Ancillary data can be concurrently transmitted over a common transmission system with a compressed audio signal. Control of the system's configuration parameters is achieved by programming performed through an attached PC or computer terminal.

Despite the numerous known CODECs, none of the known CODECs have an embedded user-friendly configuration routine which recognizes installed circuit option cards and that can guide the user through a configuration set-up sub-routine corresponding to each of the installed circuit option cards using an on-board integral hardware interface. Additionally, none of the known CODECs provide a configuration menu of user-adjustable configuration parameter options on an integral display interface and receive user-selected configuration parameter options through the integral interface. Moreover, none of the known CODECs provide interactive hot-swap capabilities whereby circuit option cards can be added and removed while in a power-on mode and in which the CODEC recognizes a changed hardware configuration and in response thereto prompts the user to set up the changed hardware configuration by presenting a configuration menu corresponding to the changed hardware configuration on the integral display interface.

Furthermore, none of the known CODECs have the ability to perform multiple audio transmission such as encoding, compressing and transmitting audio through ISDN, T1 and E1 facilities while simultaneously providing streaming audio over a network such as a local area network (LAN), metropolitan area network (MAN), wide area network (WAN), or a world-wide-web (the Internet).

Thus, in spite of the numerous existing or published patents and known prior art devices there remains a need for an audio CODEC with audio/data communications gateway adapted to guide a user through an embedded user-friendly configuration routine which recognizes installed circuit option cards and is adapted to provide a configuration menu of user-adjustable configuration parameter options on an integral display interface and to receive user-selected configuration parameter options through said interface; and which provides interactive hot-swap capabilities whereby selected circuit option cards can be plugged into and/or unplugged from the audio CODEC with audio/data communications gateway while in a power-on state; and in which the audio CODEC with audio/data communications gateway recognizes a changed hardware configuration and prompts the user through a configuration menu corresponding to the changed hardware configuration.

Moreover, there is a need for an audio CODEC with audio/data communications gateway that has the ability to perform multiple audio transmission such as simultaneously encoding, compressing and transmitting audio through ISDN, T1 or E1 facilities while providing streaming audio over a network.

### SUMMARY OF THE INVENTION

The present inventive subject matter relates to an audio CODEC with audio/data communications gateway having an integral interface panel adapted to display a configuration parameter option to a user and to receive a corresponding configuration parameter option setting from a user.

The present inventive subject matter further relates to a method of configuring the audio CODEC with audio/data communications gateway by: providing a control processor circuit card having a configuration software program stored thereon, the configuration software program adapted to identify at least one of a plurality of function modules inserted into slots of the audio CODEC with audio/data communications gateway; providing a selection control whereby a user is provided with an ability to select one of the plurality of function modules to be configured; providing a configuration menu to the interface panel corresponding to the selected function module, the configuration menu having the configuration parameter option; displaying the configuration menu on a visual display carried by the interface panel; navigating through the configuration menu by selectively manipulating a navigation control thereby displaying the configuration parameter option on the visual display; entering the corresponding configuration parameter option setting into the interface panel; and storing the configuration parameter option setting into a memory.

Another embodiment of the present inventive subject matter is a control processor of the audio CODEC with audio/data communications gateway which recognizes the presence of each of a plurality of function modules and provide a configuration menu corresponding to the recognized modules.

Yet another embodiment of the present inventive subject matter is an audio CODEC with audio/data communications gateway which provides a method of streaming an audio signal over a network concurrent with transmission of an encoded audio signal over a digital transmission facility, comprising providing an input audio signal to the audio CODEC with audio/data communications gateway; outputting an output signal from the audio CODEC with audio/data communications gateway to a network media server; and streaming the signal provided to the network media server over the network.

Still another embodiment of the present inventive subject matter is an audio CODEC with hot swappable audio/data communications gateway which comprises a housing; an integral interface panel carried by the housing, the interface panel adapted to display a configuration parameter option to a user and to receive a corresponding configuration parameter option setting from the user; a plurality of function modules; a plurality of slots in the housing, each having a corresponding external access opening adapted to receive a selected one of the function modules, wherein at least one of said plurality of function modules is hot swappable through a port into a bus; a control processor circuit card insertable into a first one of said plurality of slots; a configuration software program stored on the control processor circuit card, the configuration program adapted to identify at least one of the function modules inserted into another of the slots, and to provide a corresponding configuration menu having the configuration parameter option to the interface panel, and to receive the corresponding configuration parameter option setting from the interface panel.

Yet another embodiment of the present inventive subject matter is an interconnected first hot swappable audio and data communications gateway apparatus and a second hot swappable audio and data communications gateway apparatus, each comprising: an interface panel adapted to display a configuration parameter option to a user and to receive a corresponding configuration parameter option setting from a user; at least one of a plurality of function modules, wherein at least one of said plurality of function modules is hot swappable through a port into a bus; a control processor circuit card; a configuration software program stored on said control processor circuit card, said configuration program adapted to identify at least one of said plurality of function modules, and to provide a corresponding configuration menu having said configuration parameter option to said interface panel, and to receive said corresponding configuration parameter option setting from said interface panel; a first input for inputting an input signal; a first output for outputting an output signal, the output signal being related to the input signal according to said selected one of said plurality of function modules and said corresponding configuration parameter option setting.

Yet another embodiment of the present inventive subject matter is a method of streaming an audio signal over a network comprising providing an input audio signal to a hot swappable audio and data communications gateway apparatus; providing an output signal from the audio and data communications gateway apparatus to a network media server; transmitting the signal provided to the network media server over the network; and receiving the transmitted signal; wherein said hot swappable audio and data communications gateway apparatus comprises: a housing; an integral interface panel carried by said housing, said interface panel adapted to display a configuration parameter option to a user and to receive a corresponding configuration parameter option setting from the user; a plurality of slots in said housing, each having a corresponding external access opening adapted to receive a selected one of a plurality of function modules, wherein at least one of said plurality of function modules is hot swappable through a port into a bus; a control processor circuit card insertable into a first one of said plurality of slots; and a configuration software program stored on said control processor circuit card, said configuration program adapted to identify at least one of said plurality of function modules inserted into another of said plurality of slots, and to provide a corresponding configuration menu having said configuration parameter option to said interface panel, and to receive said corresponding configuration parameter option setting from said interface panel.

Still another embodiment of the present inventive subject matter is a hot swappable audio and data communications gateway apparatus comprising: a housing having a front end and a back end; an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel; a first slot in said back end of said housing having a corresponding external access opening; a plurality of additional slots in said back end of said housing, each of said additional slots having a corresponding external access opening adapted to receive a selected one of a plurality of function modules, wherein at least one of said plurality of function modules is hot swappable through a port into a bus; a control processor circuit card insertable into said first slot; and a configuration software program stored on said control processor circuit card, said configuration program adapted to identify at least one of said plurality of function modules inserted into one of said plurality of additional slots, and to provide a corresponding configuration menu having said configuration parameter option to said interface panel, and to receive said corresponding configuration parameter option setting from said interface panel.

Still yet another embodiment of the present inventive subject matter is a hot swappable audio and data communications gateway apparatus comprising: a housing having a front end and a back end; an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel; a first slot in said back end of said housing having a corresponding external access opening; three additional slots in said back end of said housing, each of said additional slots having a corresponding external access opening adapted to receive a selected one of a plurality of function modules, wherein at least one of said plurality of function modules is hot swappable; a control processor circuit card insertable into said first slot; and a configuration software program stored on said control processor circuit card, said configuration program adapted to identify at least one of said plurality of function modules inserted into one of said three additional slots, and to provide a corresponding configuration menu having said configuration parameter option to said interface panel, and to receive said corresponding configuration parameter option setting from said interface panel.

Still another embodiment of the present inventive subject matter is a hot swappable audio and data communications gateway apparatus comprising:a housing having a front end and a back end; an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel; a first slot in said back end of said housing having a corresponding external access opening; a second, third, and fourth slots in said back end of said housing, each of said second, third, and fourth slots having a corresponding external access opening; a control processor circuit card inserted into said first slot; a T1 multiplexer module inserted into said second slot; a full bi-directional CODEC module inserted into said third slot; an ISDN terminal adapter module inserted into said fourth slot; and a configuration software program stored on said control processor circuit card, said configuration program adapted to identify at least one of said modules inserted into one of said second, third, and fourth slots, and to provide a corresponding configuration menu having said configuration parameter option to said interface panel, and to receive said corresponding configuration parameter option setting from said interface panel; wherein at least one of said modules is hot swappable.

Yet another embodiment of the present inventive subject matter is a hot swappable audio and data communications gateway apparatus comprising: a housing having a front end and a back end; an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel; a first slot in said back end of said housing having a corresponding external access opening; three additional slots in said back end of said housing, each of said additional slots having a corresponding external access opening adapted to receive a selected one of a plurality of function modules, wherein a full bi-directional CODEC module is inserted into one of said three additional slots, the remainder of the plurality of function modules selected from the group consisting of an ISDN terminal adapter, a T1 multiplexer, an E1 multiplexer, a V.35 digital interface module, and an X.21/RS422 digital interface module; a control processor circuit card inserted into said first slot; and a configuration software program stored on said control processor circuit card, said configuration program adapted to identify at least one of said modules inserted into one of said second, third, and fourth slots, and to provide a corresponding configuration menu having said configuration parameter option to said interface panel, and to receive said corresponding configuration parameter option setting from said interface panel; wherein at least one of said modules is hot swappable.

Still another embodiment of the present inventive subject matter is a hot swappable audio and data communications gateway apparatus comprising: a housing having a front end and a back end; an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel; a first slot in said back end of said housing having a corresponding external access opening; three additional slots in said back end of said housing, each of said additional slots having a corresponding external access opening adapted to receive a selected one of a plurality of function modules, wherein an encoder module is inserted into one of said three additional slots, the remainder of the plurality of function modules selected from the group consisting of a decoder module, an ISDN terminal adapter, a T1 multiplexer, an E1 multiplexer, a V.35 digital interface module, and an X.21/RS422 digital interface module; a control processor circuit card inserted into said first slot; and a configuration software program stored on said control processor circuit card, said configuration program adapted to identify at least one of said modules inserted into one of said second, third, and fourth slots, and to provide a corresponding configuration menu having said configuration parameter option to said interface panel, and to receive said corresponding configuration parameter option setting from said interface panel; wherein at least one of said modules is hot swappable.

Still yet another embodiment of the present inventive subject matter is a hot swappable audio and data communications gateway apparatus comprising: a housing having a front end and a back end; an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel; a first slot in said back end of said housing having a corresponding external access opening; three additional slots in said back end of said housing, each of said additional slots having a corresponding external access opening adapted to receive a selected one of a plurality of function modules, wherein a decoder module is inserted into one of said three additional slots, the remainder of the plurality of function modules selected from the group consisting of an encoder module, an ISDN terminal adapter, a T1 multiplexer, an E1 multiplexer, a V.35 digital interface module, and an X.21/RS422 digital interface module; a control processor circuit card inserted into said first slot; and a configuration software program stored on said control processor circuit card, said configuration program adapted to identify at least one of said modules inserted into one of said second, third, and fourth slots, and to provide a corresponding configuration menu having said configuration parameter option to said interface panel, and to receive said corresponding configuration parameter option setting from said interface panel; wherein at least one of said modules is hot swappable.

Yet another embodiment of the present inventive subject matter is a hot swappable audio and data communications gateway apparatus comprising: a housing having a front end and a back end comprised of a steel chassis; an integral interface panel located at said front end of said housing, said interface panel adapted to display a configuration parameter option to a user and to receive a corresponding configuration parameter option setting from the user, said interface panel containing thereon a circular navigation switch wheel, an alpha-numeric keypad, a plurality of programmable function keys, a backlit alphanumeric LCD visual display panel configured for 30 characters by 4 lines, a VU meter, a headphone output jack, a volume control, and an adjustable display contrast; an international power supply; two fans for cooling said apparatus; a first slot in said back end of said housing having a corresponding external access opening; three additional slots in said back end of said housing, each of said additional slots having a corresponding external access opening adapted to receive a selected one of a plurality of function modules selected from the group consisting of an encoder module, a decoder module, a full bi-directional CODEC module, an ISDN terminal adapter, a T1 multiplexer, an E1 multiplexer, a V.35 digital interface module, and an X.21/RS422 digital interface module, wherein at least one of said plurality of function modules is hot swappable through a port into a bus; a power cord connector socket in said back end of said housing; a power switch in said back end of said housing; a control processor circuit card insertable into said first slot; an ethernet connectivity port contained on said control processor circuit card; a configuration software program stored on said control processor circuit card, said configuration program adapted to identify at least one of said plurality of function modules inserted into one of said three additional slots, and to provide a corresponding configuration menu having said configuration parameter option to said interface panel, and to receive said corresponding configuration parameter option setting from said interface panel; a first input in said back end of said module for inputting an input signal; and a first output in said back end of said module for outputting an output signal, the output signal being related to the input signal according to said selected one of said plurality of function modules and said corresponding configuration parameter option setting.

In a preferred embodiment, the hot swappable audio and data communications gateway apparatus has two vertical stacks of LED which have two VU meters, one for each channel, Left Channel and Right Channel. In an additional preferred embodiment there are 4 VU meters for monitoring both the signal being sent (Send) and the signal being received (Receive) for each channel, Left and Right.

These and other embodiments of the present inventive subject matter will be better understood by those skilled in the art by reference to the following detailed description taken together with the following drawings in which like numerals identify like components throughout the several views.

### BRIEF DESCRIPTION OF THE DRAWINGS

FIG. 1 is a front elevational view of a particularly preferred embodiment of the audio CODEC with audio/data communications gateway of the present invention and showing an interface panel.

FIG. 2 is a rear elevational view of the apparatus of the present invention showing a control processor function module and 3 optional function modules inserted into corresponding rear slots of the apparatus of FIG. 1.

FIG. 2a is an enlarged view of a control processor function module.

FIG. 2b is an enlarged view of a combined encoder/decoder (CODEC) function module.

FIG. 2c is an enlarged view of an encoder function module.

FIG. 2d is an enlarged view of a decoder function module.

FIG. 2e is an enlarged view of an E1 multiplexer interface function module.

FIG. 2f is an enlarged view of a T1 multiplexer interface function module.

FIG. 2g is an enlarged view of a V.35 digital interface function module.

FIG. 2h is an enlarged view of an X.21 digital interface function module.

FIG. 2i is an enlarged view of a 3 BRI ISDN terminal adapter function module.

FIG. 3 shows an exemplary display of a home display on a visual display panel and an accompanying navigation control for moving a cursor on the home display.

FIG. 4 shows an exemplary basic configuration screen for an encoder.

FIG. 5 is an electrical schematic diagram of a backplane of the apparatus of FIG. 1.

FIG. 5a is a schematic diagram of a TDM bus of the backplane of FIG. 5.

FIG. 5b is a schematic diagram of a P-bus of the backplane of FIG. 5.

FIG. 5c is a schematic diagram of an A-bus of the backplane of FIG. 5.

FIG. 6 is a schematic diagram of a phase-lock loop circuit of the control processor of FIG. 2a.

FIG. 7 is a schematic diagram of an Ethernet interface of the control processor of FIG. 2a.

FIG. 8 is a schematic diagram of an ancillary data port of the control processor of FIG. 2a.

FIG. 9 is a schematic diagram of the alarm relays of the control processor of FIG. 2a.

FIG. 10 is a flowchart of the Basic Encoder Setup routine.

FIG. 10a is a flowchart of the Line Format options.

FIG. 10b is a flowchart of the Sample Rate options.

FIG. 10c is a flowchart of the Algorithm Mode options.

FIG. 11 is a flowchart of the Advanced Encoder Setup routine.

FIG. 11a is a flowchart of the Ancillary Data Format options.

FIG. 11b is a flowchart of the Ancillary Data Bit rate options.

FIG. 12 is a flowchart of the Basic Decoder Setup routine.

FIG. 13 is a flowchart of the Advanced Decoder Setup options.

FIG. 14 is a flowchart of the Network Connection Configuration routine.

### DETAILED DESCRIPTION OF THE PREFERRED EMBODIMENT

The term “hot swappable” as used herein refers to plug-in function modules which can be removed from and/or inserted into housing 105 while audio CODEC with audio/data communications gateway 100 is in a power-on mode. These function modules are hot swappable through a port into a bus. The audio CODEC with audio/data communications gateway 100 can recognize a changed hardware configuration and can prompt the user to reconfigure applicable control processor settings through a configuration menu corresponding to the changed hardware configuration.

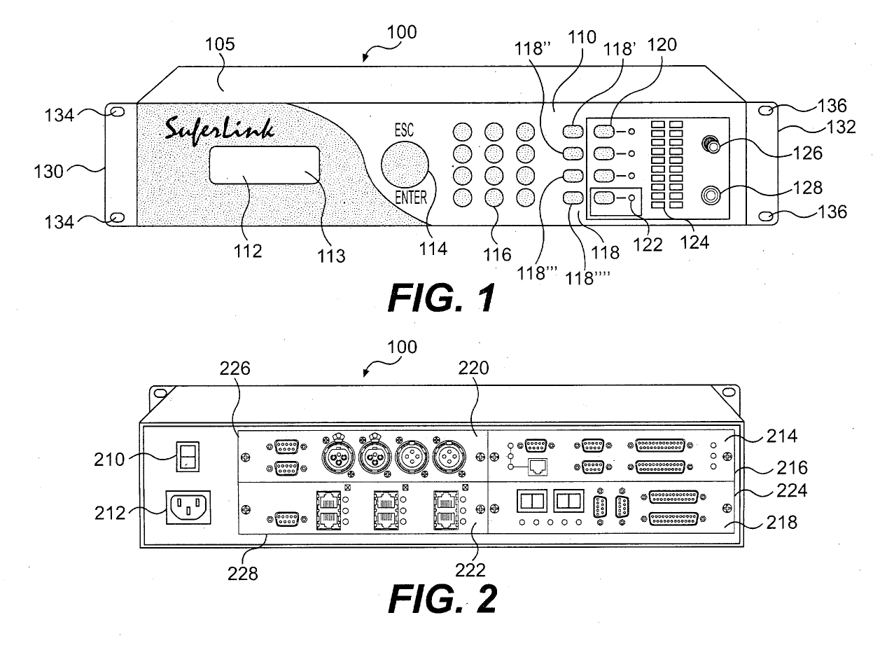

With reference to the figures in which like numerals represent like elements or components throughout the several views, and in particular with reference to FIG. 1, there is shown a currently preferred particular embodiment of a convertible, table top/rack mountable, integrated audio CODEC with audio/data communications gateway 100 according to the present invention.

Audio CODEC with audio/data communications gateway 100 has a housing 105 having an interface panel 110 disposed on a front portion thereof. A visual display panel 112 is mounted on one side of interface panel 110. In the particularly preferred embodiment of FIG. 1 visual display panel 112 is a 30 character by 4-line backlit alphanumeric liquid crystal display (LCD) panel 113. Other types of display panels, such as, but not limited to LED and plasma display panels can also be used. A circular navigation switch wheel 114, a telephone-style alpha-numeric data entry keypad 116, dial keys 118, function keys 120, indicator light emitting diodes (LEDs) 122, dual channel vu meters 124, volume control 126 and a headphone output jack 128, respectively, are also provided on interface panel 110. For rack-mount installations, optional mounting flanges 130, 132 can be connected to respective sides of housing 105. Mounting flanges 130 and 132 have mounting holes 134 and 136, respectively, therethrough. Alternatively, for table top installation applications, mounting flanges 130 and 132 can be omitted and, in lieu thereof, mounting feet (not shown) can be connected to a bottom of housing 105.

Audio CODEC with audio/data communications gateway 100 can be configured as a multi channel high-fidelity bi-directional audio CODEC or as a gateway for streaming audio over a network such as an Internet. Audio CODEC with audio/data communications gateway 100 provides full compatibility with all existing G.722 and MPEG based CODECs and can also transmit nearly uncompressed audio over T1 and E1 networks, where ‘nearly uncompressed’ may alternatively be described as a bandwidth-limited or truncated audio without loss of any perceptible signal. The present inventive subject matter can use the J57 algorithm, which is known to be a type of compressed audio, to achieve a ‘nearly uncompressed’ audio by transmitting over T1 at lower resolution, lower sample rate, and limiting the frequency response, e.g. 15 KHz, but importantly is not technically A to D direct, CD quality unencoded audio.

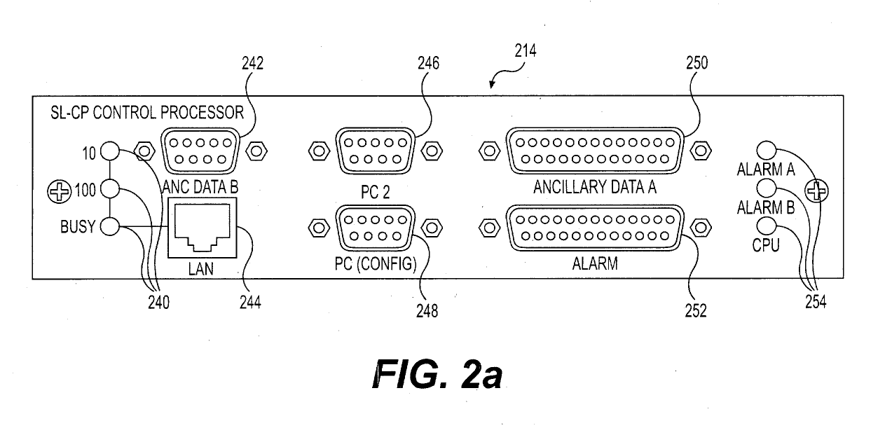

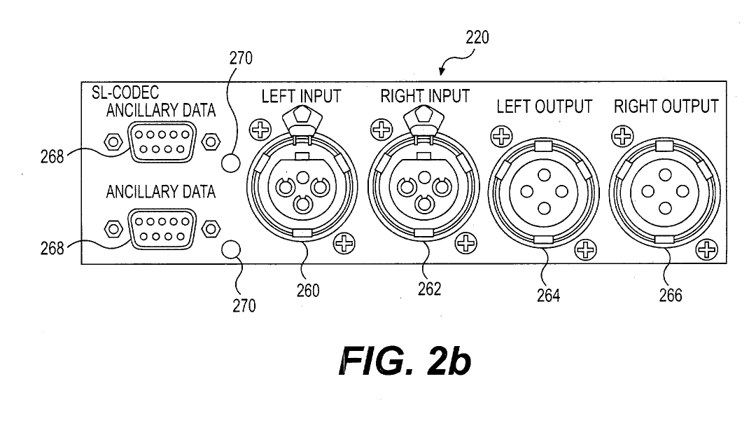

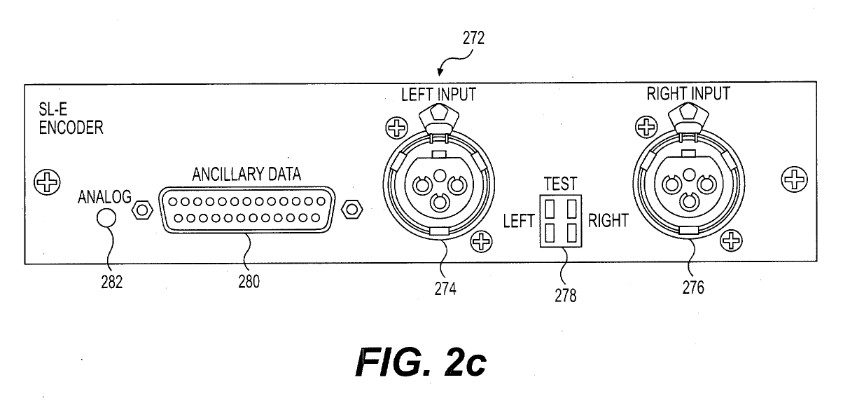

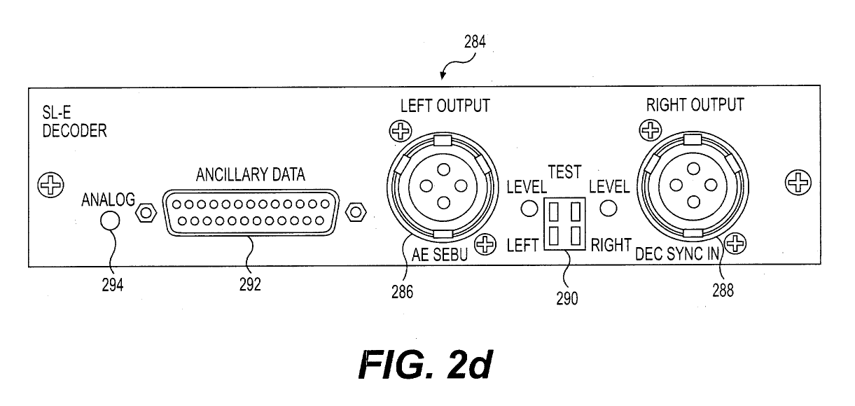

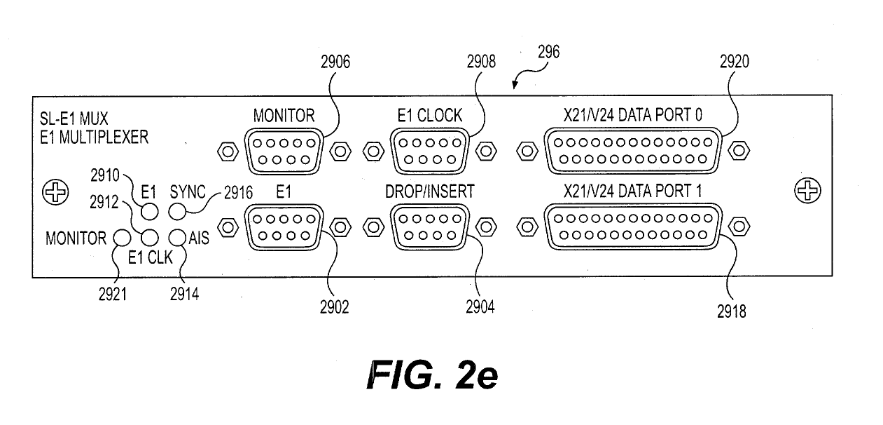

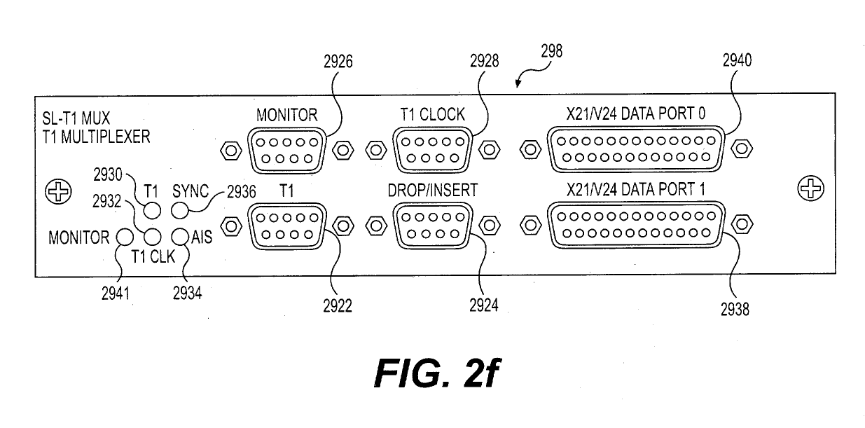

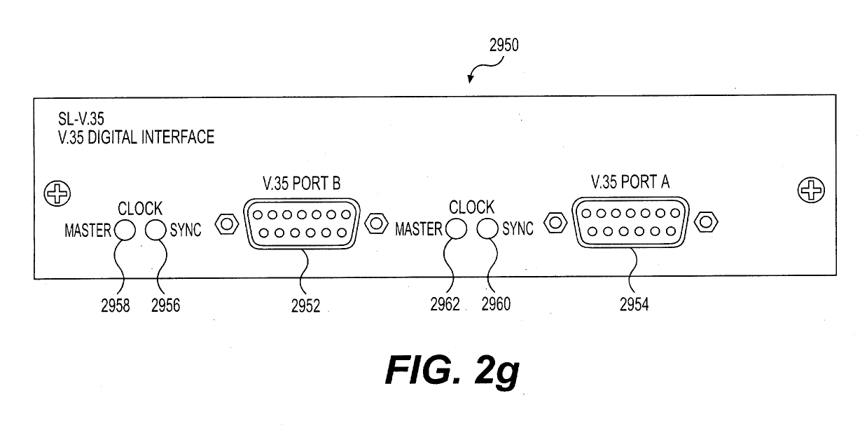

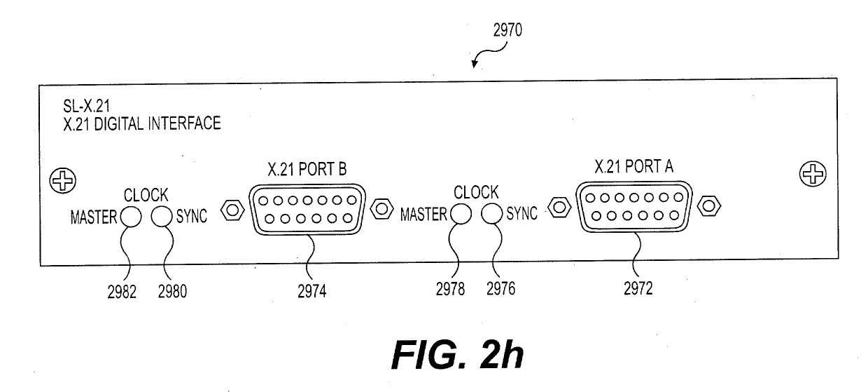

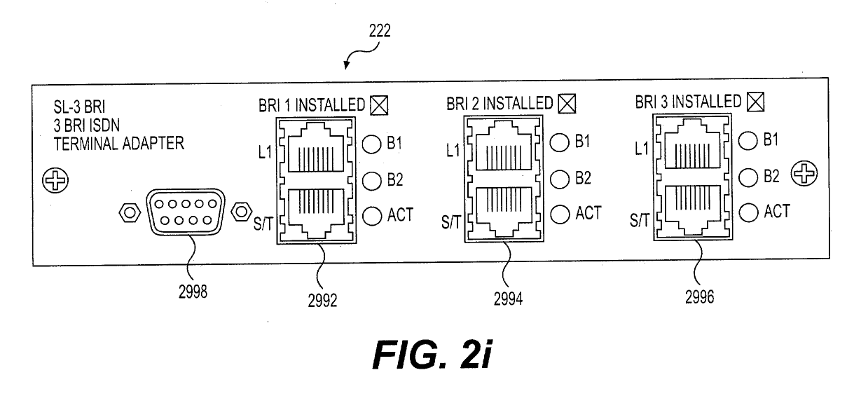

With reference to FIG. 2, a rear view of Audio CODEC with audio/data communications gateway 100 is shown. Housing 105 has an on-off switch 210 and a power cord connector socket 212 mounted to a rear thereof. An internal power supply (not shown) is connected to switch 210 and socket 212 in a conventional manner and provides electrical power to all internal circuitry via an internal bus. The internal power supply is adapted to be compatible with all commonly commercially available voltages and frequencies of electrical current provided by public utility grids throughout the world without setting additional jumpers and switches.

Housing 105 has a plurality of externally accessible slots each adapted to receive a selected one of a group of plug-in function modules. A control processor function module 214 is insertable into a first externally accessible slot 216. In addition to control processor function module 214 which is always required, up to 3 additional function modules, such as function modules 218, 220, and 222, can be inserted into corresponding ones of slots 224, 226 and 228 in housing 105. Other function modules, such as those shown in FIGS. 2b-2i, can be inserted into one or more of slots 224, 226 and 228 in lieu of one or more of function modules 218, 220 and 222. Selection of how many of each type of function module and which function module is to be to be inserted into each of the respective externally accessible slots 224, 226 and 228 of housing 105 is performed by a user. Selected ones of the function modules (other than control processor 214), are hot swappable—that is, they can be removed from and/or inserted into housing 105 while audio CODEC with audio/data communications gateway 100 is in a power-on mode.

In addition to required control processor 214, optional function modules include: full bi-directional CODEC 220; an encoder module shown in FIG. 2c; a decoder module shown in FIG. 2d; an E1 multiplexer shown in FIG. 2e; T1 multiplexer 218, a preferred embodiment of which is shown in FIG. 2f; a V.35 digital interface module shown in FIG. 2g; an X.21/RS422 digital interface module shown in FIG. 2h; and a 3-BRI ISDN terminal adapter 222, as well as 1- and 2-BRI versions of ISDN terminal adapters (not shown);

In FIG. 2a an enlarged view of control processor 214 of FIG. 2 is shown. Control processor 214 has a plurality of LEDs 240; an ancillary data port 242; an Ethernet or TELCO LAN jack 244; connectors 246, and 248; connectors 250 and 252; and alarm LEDs 254.

LEDs 240 indicate status of a connected external network (not shown).

Ancillary data connectors 242 and 250 are mappable to a separate E1 or T1 multiplexer function module, such as E1 multiplexer 296 shown in FIG. 2e and T1 multiplexer 298 shown in FIG. 2f; or mappable to a CODEC, such as CODEC 220 sown in FIG. 2b, or to an encoder, such as encoder 272 shown in FIG. 2c, or to a decoder, such as decoder 284 shown in FIG. 2d. Ancillary data connectors 242 and 250 are in addition to and independent of ancillary data ports provided on the T1 and/or E1 function modules.

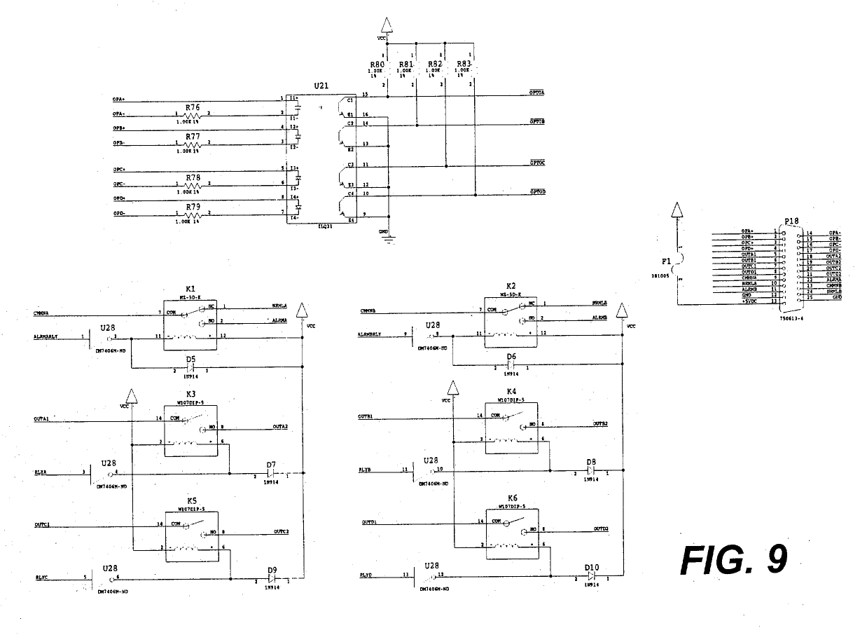

Ethernet or TELCO LAN jack 244 permits connection to an external network (not shown). Connectors 246 and 248 provide connection points for an optionally connected PC (not shown) that can be used to provide remote control of audio CODEC with audio/data communications gateway 100 over an Internet (not shown), or for downloading software updates and pre-determined configuration programs onto audio CODEC with audio/data communications gateway 100. Connector 250 provides a connection point for a source of ancillary data (not shown) and can receive an ancillary data signal (not shown) from the ancillary data source. Connector 252 provides connection to external alarm circuits (not shown); and, in the preferred embodiment of FIG. 2a, provides output connections from six alarm relays 902, 904, 906, 908, 910, and 912 shown in FIG. 9. Alarm LEDs 254 provide status indication for programmed and/or hardware alarm conditions.

In FIG. 2b an enlarged view of CODEC function module 220 of FIG. 2 is shown. CODEC function module 220 includes in a single function module the features of both an encoder, such as the encoder shown in FIG. 2c, and a decoder, such as the decoder shown in FIG. 2d. CODEC module 220 has a left channel audio input jack 260 and a right channel audio input jack 262; and has a left channel audio output jack 264 and a right channel audio output jack 266. Two ancillary data jacks 268; and two analog status indicators 270, one corresponding to each of ancillary data jacks 268, are also provided on CODEC 220. Ancillary data jacks 268 provide connection points for an ancillary data source (not shown).

In FIG. 2c an enlarged view of encoder function module 272 is shown. Encoder function module 272 has a left channel audio input jack 274; a right channel audio input jack 276; a right and left input test jack 278; an ancillary data jack 280; and an analog status indicator 282. As with ancillary data jacks 268 of CODEC 220, ancillary data jack 280 provides a connection point for an ancillary data source (not shown).

In FIG. 2d an enlarged view of decoder function module 284 is shown. Decoder function module 284 has a left channel audio output jack 286; a right channel audio output jack 288; an output test jack 290; an ancillary data jack 292; and an analog status indicator 294. Ancillary data jack 292 can be used to output ancillary data sent from a far-end encoder or CODEC when using any MPEG algorithm.

In FIG. 2e an enlarged view of E1 multiplexer function module 296 is shown. E1 multiplexer 296 has a connector 2902 for an external E1 communications line (not shown); a drop/insert connector 2904 for another E1 communications line (not shown); a connector 2906 for an external test device (not shown); and a connector 2908 for an external E1 clock (not shown). The E1 multiplexer also has an E1 LED 2910; an E1 clock LED 2912; an AIS LED 2914; and a sync LED 2916. Two X.21/V.24 compatible data ports 2918, 2920 and a monitor LED 2921 are also connected to E1 multiplexer 296.

Connector 2904 provides a drop/insert connection point for a second E1 line. The primary network interface is bi-directional main E1 connector 2902. Audio and ancillary data from encoders (such as encoder function module 272) and CODECs (such as CODEC function module 220) is multiplexed with data from the drop/insert connector 2904 and the two data ports 2918, 2920 and is output through main E1 connector 2902. Data coming into connector 2902 is demultiplexed and sent to the appropriate location, decoders, CODECs, drop/insert port 2904, or the other user interfaces. Data to and from the bi-directional drop/insert connector 2904 is multiplexed/demultiplexed with other audio and ancillary data internally in E1 multiplexer 296. Connector 2904 can also be used as a second primary E1 interface allowing transmission of audio to two locations.

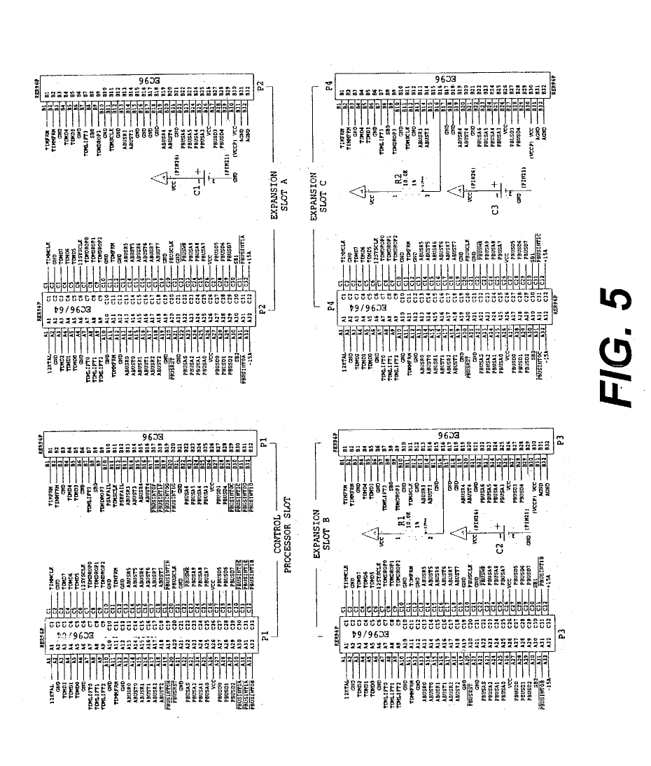

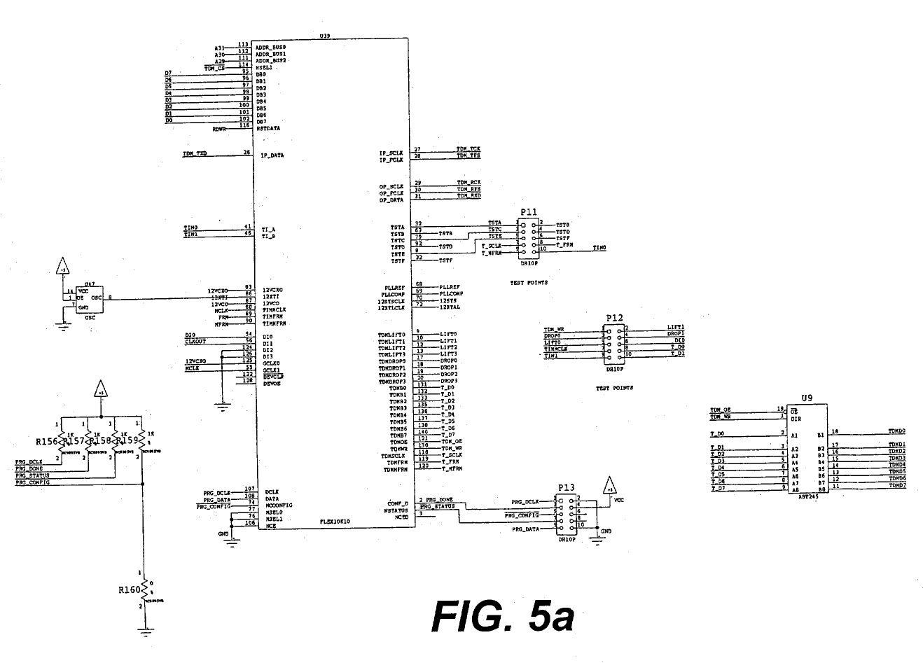

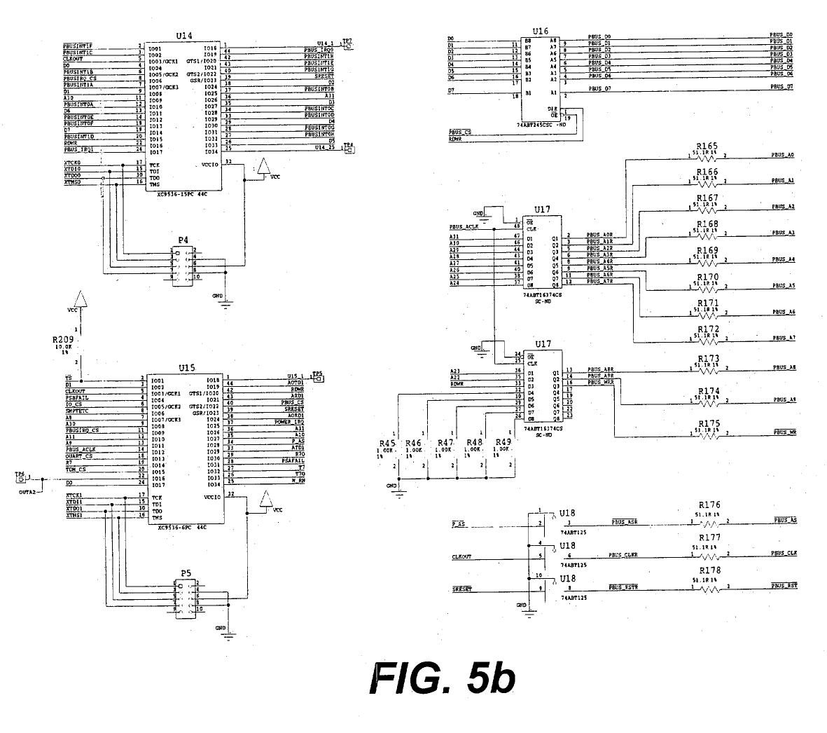

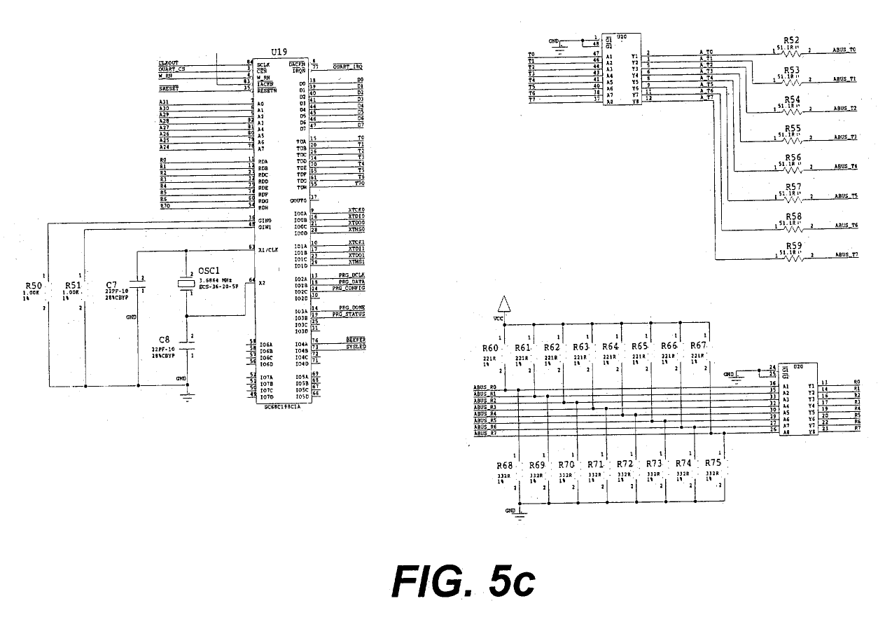

Data ports 2918, 2920 are configured for X.21 and V.24 asynchronous bi-directional data and are independent of audio CODEC with audio/data communications gateway 100's encoder/decoder functions. Date at connectors 2918, 2920 is retrieved or inserted from/to time slots on backplane 500, shown in FIG. 5.

E1 LED 2910 and E1 clock LED 2912 indicate a status of the external E1 line connected to connector 2902 while AIS LED 2914 and sync LED 2916 provide visual indication of mixing and matching of time slots in the output data stream associated with the data stream from the E1 line connected to E1 connector 2902 and the data stream from the E1 line connected to drop/insert connector 2904. Monitor LED 2921 indicates when an internal system clock (not shown) of E1 multiplexer 296 is used for system timing.

In FIG. 2f an enlarged view of a preferred embodiment of T1 multiplexer function module 298 is shown. T1 multiplexer 298 is functionally identical to T1 multiplexer 218 shown in FIG. 2. However, in the preferred embodiment of FIG. 2f, the geometric arrangement of certain of the externally visible components and the type of externally visible electrical connectors used differ from those shown in T1 multiplexer 218. For ease of presentation, only the preferred embodiment of T1 multiplexer 298 will be described herein in detail, all such descriptions being equally applicable to corresponding components of T1 multiplexer 218.

T1 multiplexer 298 has a connector 2922 for an external T1 communications line (not shown); a drop/insert connector 2924 for another T1 communications line (not shown); a connector 2926 for an external test device (not shown); and a connector 2928 for an external T1 clock (not shown). T1 multiplexer also has a T1 LED 2930; an T1 clock LED 2932; an AIS LED 2934; and a sync LED 2936. Two X.21/V.24 compatible data ports 2938, 2940 and a monitor LED 2941 are also connected to T1 multiplexer 298.

Connector 2924 provides a drop/insert connection point for a second T1 line. The primary network interface is bi-directional main T1 connector 2922. Audio and ancillary data from encoders (such as encoder function module 272) and CODECs (such as CODEC function module 220) is multiplexed with data from the drop/insert connector 2924 and the two data ports 2938, 2940 and is output through main T1 connector 2922. Data coming into connector 2922 is demultiplexed and sent to the appropriate location, decoders, CODECs, drop/insert port 2924, or the other user interfaces. Data to and from the bi-directional drop/insert connector 2924 is multiplexed/demultiplexed with other audio and ancillary data internally in T1 multiplexer 298. Connector 2924 can also be used as a second primary T1 interface allowing transmission of audio to two locations.

Data ports 2938, 2940 are configured for X.21 and V.24 asynchronous bi-directional data and are independent of audio CODEC with audio/data communications gateway 100's encoder/decoder functions. Date at connectors 2938, 2940 is retrieved or inserted from/to time slots on backplane 500.

T1 LED 2930 and T1 clock LED 2932 indicate a status of the external T1 line connected to connector 2922 while AIS LED 2934 and sync LED 2936 provide visual indication of mixing and matching of time slots in the output data stream associated with the data stream from the T1 line connected to T1 connector 2922 and the data stream from the T1 line connected to drop/insert connector 2924. Monitor LED 2941 indicates when an internal system clock (not shown) of T1 multiplexer 298 is used for system timing.

In FIG. 2g an enlarged view of a V.35 digital interface function module 2950 is shown. V.35 module 2950 has two V.35 compatible ports 2952 and 2954. Ports 2952 and 2954 each have two clock LEDs associated therewith. Port 2952 has a sync LED 2956 and a master LED 2958; and port 2954 has a sync LED 2960 and a master LED 2962. V.35 function module 2950 supports N×64 kb/sec transmission. Connection ports 2952, 2954 can be configured independently.

In FIG. 2h an enlarged view of a X.21 digital interface function module 2970 is shown. X.21 module 2970 has two X.21 compatible ports 2972 and 2974. Ports 2972 and 2974 each have two clock LEDs associated therewith. Port 2972 has a sync LED 2976 and a master LED 2978; and port 2974 has a sync LED 2980 and a master LED 2982. X.21 function module 2970 supports N×64 kb/sec transmission. Connection ports 2972, 2974 can be configured independently.

In FIG. 2i an enlarged view of a 3-BRI ISDN terminal adapter function module 222 is shown. Terminal adapter 222 has a connector 2992 for a first ISDN line; a connector 2994 for a second ISDN line; a connector 2996 for a third ISDN line; and a connector 2998 for ancillary data.

3-BRI ISDN terminal adapter 222 supports up to 3 ISDN BRIs for multiple audio connections and can broadcast monaural programs to up to 6 locations, stereo to 3 locations, or two stereo programs to different locations simultaneously. Both North American (U) and European (S/T) ISDN interfaces are provided for each BRI, and status LED's are included.

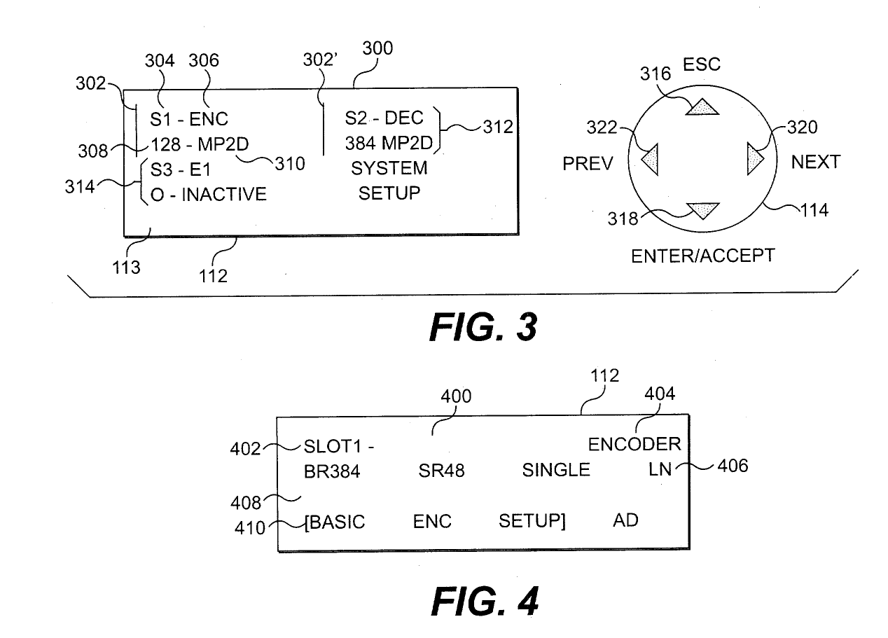

Referring now to FIG. 3, a typical “home” display 300 of visual display panel 112 and navigation switch wheel 114 is shown.

In home display 300, a pair of blinking cursor bars 302, 302′ highlight a current cursor location corresponding to a first one of slots 224, 226, and 228. In a first line between cursor bars 302, 302′ a slot indicator 304 indicates the currently selected slot “S1”. Adjacent thereto at 306 a detected type of function module “ENC” (encoder) present in slot “S1” is displayed. In a next line between cursor bars 302, 302′ a currently enabled configuration setting 308 (128 kb/sec) and an enabled encoding algorithm 310 (MUSICAM-enhanced MPEG Layer II, dual mono) for the detected function module is displayed. To the right of cursor bar 302′ two similar lines of data 312 display a currently detected status of a function module in slot “S2”; and below cursor bars 302, 302′ at 314 two similar lines of data 314 display the currently detected status of a function module in slot “S3”.

Referring now to FIG. 4, a typical basic configuration screen 400 for an encoder, such as encoder 272, is shown. Most configuration menus are arranged in a “top-down” or “step-through” programming sequence. Thus, a programming selection can invoke a dependent tree of further programming options which further modify a selected configuration parameter option. The first two lines of a configuration screen, such as screen 400, are for information purposes only and show current device configuration and other information. As shown in FIG. 4 slot identifier 402 identifies the selected slot in which the function module to be configured is located. The type of function module is displayed at 404. Currently selected or currently enabled default parameter settings are shown at 406. A third line 408 (blank in FIG. 4) provides information such as menu branch, status and error messages. A fourth line 410 is for parameter selection.

Referring to FIG. 5, an electrical schematic diagram of backplane 500 of audio CODEC with audio/data communications gateway 100 has a control processor branch 502, and branches 504, 506, and 508 corresponding to function module plug-in slots 224, 226, 228.

Referring now to FIGS. 5a-5c, schematic diagrams of TDM T-bus 550, P-bus 560, and A-bus 570 of backplane 500 are shown. Circuit connections corresponding to the various circuit elements of each of TDM T-bus 550, P-bus 560 and A-bus 570 are present at each of branches 502, 504, 506 and 508 of backplane 500.

Audio CODEC with audio/data communications gateway 100 is a modular table-top and rack mountable audio CODEC and audio/data communications gateway centered around a plug-in circuit card control processor function module 214 based on a Motorola MPC860 Power PC based microprocessor controller with Flash ROM based technology. Audio CODEC with audio/data communications gateway 100 can be further configured by adding up to 3 hot swappable plug-in function modules, such as modules 218, 220, 222; and is powered by an internal AC supply or optionally a 60V DC supply.

Audio CODEC with audio/data communications gateway 100 can be used with a variety of digital transmission facilities such as ISDN, satellite and dedicated facilities, 10 Base-T networks, T1 and E1 networks; and can be configured to operate in a send-only, receive-only or bi-directional mode with up to four audio channels.

Audio CODEC with audio/data communications gateway 100 can be configured as a multi-channel high fidelity bi-directional audio CODEC and a gateway for streaming audio over the Internet; is compatible with other CODECs employing G.722 and MPEG based compression algorithms; and can transmit uncompressed audio over E1 and T1 communications networks.

The essential basic configuration of Audio CODEC with audio/data communications gateway 100 includes user interface panel 110, an internal power supply (not shown), an internal bus architecture, control processor function module 214 and slots 224, 226, and 228. Slots 224, 226 and 228 are adapted to receive selected ones of optional plug-in function module circuit cards that can be installed as needed to fulfill the system requirements of a particular application; and can be removed and replaced by other types of function modules and/or software reconfigured to meet changing needs. Optional function modules include audio function modules such as CODEC 220, encoder 272, and decoder 284; network connection function modules such as E1 multiplexer 296, T1 multiplexer 298, V.35 digital interface module 2950, X.21 digital interface module 2970; and 1- 2- and 3-BRI versions of ISDN terminal adapters such as 3-BRI ISDN terminal adapter module 222.

The system architecture of audio CODEC with audio/data communications gateway 100 is built around a bi-directional, high speed serial, time division multiplexed (TDM) bus, (T-bus 550). TDM T-bus 550 carries digital data for the system. Each plug-in function module circuit card that requires access to digital data, such as compressed audio streams, ancillary data, and conventional T1 and E1 data streams, interfaces to TDM T-bus 550. An interface to TDM T-bus 550 is a standard circuit to insure uniform operation; and allows audio CODEC with audio/data communications gateway 100 to function with a wide variety of digital communication schemes by allowing particular interface cards (such as E1 multiplexer 296 or T1 multiplexer 298) to collect an input data stream from TDM T-bus 550 and convert the data stream to a format and protocol required by a connected digital communications network.

In addition to TDM T-bus 550, on backplane 500 of Audio CODEC with audio/data communications gateway 100 are a plurality of bi-directional, asynchronous serial data channels. These serial channels are at TTL logic levels and together comprise A-bus 570. A-bus 570 provides communication channels between Control Processor 214 and the various installed optional plug-in function modules. The data channels include RS232 data channels that provide transport of several types of asynchronous serial data among installed function module circuit cards. These channels are used for both data transfer and control functions. This includes control functions and ancillary data from CODEC module 220, encoder module 272, and decoder module 284; and E1 multiplexer module 296 and T1 multiplexer module 298. Control Processor module 214 acts as the center for these serial data channels and provides access to external ancillary connectors as required.

Control processor 214 interfaces to A-bus 570 through an octal UART. The UART is connected to the MPC860 microprocessor controller's external data bus. All data to/from A-bus 570 passes directly to the MPC860 through this UART. The UART has interrupt capability to notify the MPC860 of pending data or when it is awaiting data for transmission.

A-bus 570 serial channels A0 through A6 are hardwired to the UART; however, channel A7 has certain bypass functionality built into the hardware and thereby provides a switching capability. In addition to connection to the UART, the A7 channel can be tied directly to one of the ancillary data ports. This allows ancillary data to bypass the MPC860 and be routed directly to backplane 500, avoiding any processing delays.

The A7 channels can be connected to an SMPTE Time Code option port, such as a connector on the Control Processor, that can accept installation of an SMPTE Time Code option board. Serial data from the option board can then be routed directly to a desired Encoder and Decoder pair over the A7 channel.

In addition to an A-bus 570 interface, backplane 500 of Audio CODEC with audio/data communications gateway 100 has an eight bit bi-directional parallel P-bus 560 to provide a memory mapped address port from Control Processor 214 to each optional plug-in function module. P-bus 560 provides the MPC860 microprocessor controller of control processor function module 214 with a memory mapped I/O port for all installed function module circuit cards. The MPC860 uses P-bus 560 to communicate with and control all plug-in function module circuit cards. Also, since most function module circuit cards contain a TDM T-bus 550 interface circuit, P-bus 560 is also used to configure each plug-in function module's access to TDM T-bus 550.

P-bus 560 provides control and status functions for Control Processor 214 to each function module; and includes: the downloading of program code to each of the digital signal processors DSPs on installed CODEC, Encoder and Decoder function modules, programming individual function modules, resetting and configuring hardware on the function modules, and receiving current function module status information.

P-bus 560 is eight bits wide and fully bi-directional. There are ten address lines from the Control Processor to memory map P-bus 560 into the controller's memory space. An upper four address lines form a module address which allows for up to sixteen unique module addresses. A lower six lines allow for up to sixty-four locations within each module.

In addition to the eight data lines and ten address lines, various other control lines are provided from Control Processor 214. These include a read/write control line (R/W), an address stable control line (AS), as well as a separate interrupt lines from each function module card. A global reset line on backplane 500 from the Control Processor provides for a full system reset when Control Processor 214 is reset.

Finally, an 8 MHz system clock is run on backplane 500. This clock is synchronous with the controller's clock for use by any plug-in function module which might require it.

There are two functional circuits required for the TDM T-bus interface on Control Processor 214. These are the TDM System Timing circuit and the TDM Bus interface circuit.

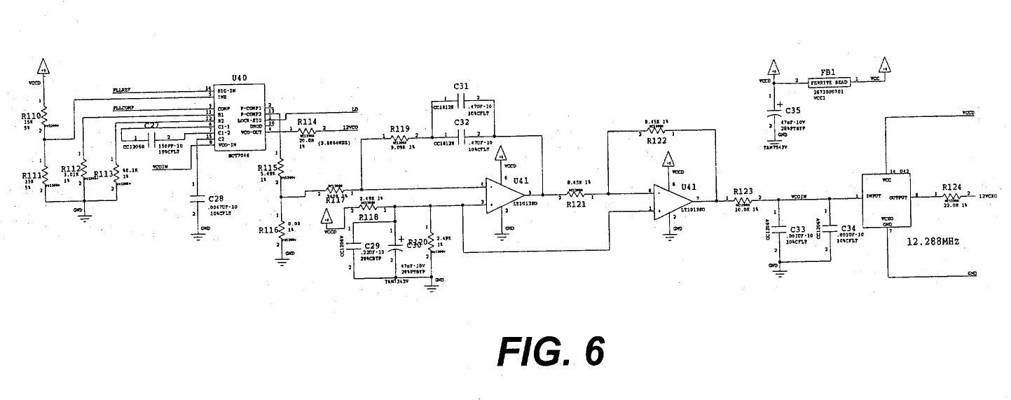

The TDM System Timing circuit is used to provide all required timing for TDM T-bus 550 on backplane 500. The circuit accepts external clocking from backplane 500 and a phase-lock loop (PLL) circuit 600 (shown in FIG. 6) couples the clock to the system's internal timing. This then is used to drive the timing for TDM T-bus 550. The external clock can come from any of plug-in function module slots 224, 226, 228. For example, one possible configuration can be for E1 multiplexer module 296 to provide this clock from an attached E1 network interface. Audio CODEC with audio/data communications gateway 100 can then become fully synchronized to an E1 network clock. In addition to the external clock, the timing circuit can lock to an internal crystal found on Control Processor 214. This allows Audio CODEC with audio/data communications gateway 100 to become a timing master. Timing for CODEC 220, Encoder 272, and Decoder 284 function modules can be provided by this circuit, thereby eliminating the need for individual PLL circuits on each CODEC, Encoder and Decoder module.

The TDM T-Bus Interface circuit on Control Processor 214 is a standard gateway to the data on TDM T-bus 550. This allows Control Processor 214 to access data on TDM T-bus 550 and process it as needed; and permits access to the TDM data from an Ethernet interface on the Control Processor.

Backplane 500 of audio CODEC with audio/data communications gateway 100 provides electrical interconnections between all of the plug-in function modules. It is a single printed circuit board mounted inside housing 105 and is divided into three main groups of connectors: a control processor group; an option module group; and a power distribution group.

Electrically, backplane 500 is divided into several functional groups of signals: a processor bus port, a timing port, a TDM T-bus port, and a power supply port.

The processor bus port provides all the signals necessary for control processor 214 to communicate with each plug-in function module. This includes an 8 bit memory mapped port, 8 asynchronous bi-directional serial ports, an interrupt control port, and miscellaneous control signals.

The timing port provides the basic system timing which is primarily TDM T-bus 550 timing. TDM T-bus Port carries the data traffic between all of the function modules. The power supply port provides power distribution for audio CODEC with audio/data communications gateway 100, and includes control and status lines used by Control Processor 214.

Control processor function module 214 is based on the MPC860 power PC communication controller. The MPC860 provides an integrated solution for the controller functions as it incorporates many of the UART, timer, address decode, memory control, and interrupt control functions which prior art devices perform discreetly. Thus, Audio CODEC with audio/data communications gateway 100 is more compact and cost effective than prior art devices. Control processor 214 is responsible for providing all user interface functions. This includes both remote control (RS232 and RS485), as well as standard keypad and LCD display capability. In addition, Control Processor 214 controls all aspects of system operation primarily through 8 bit processor P-bus 560 which connects the controller to the plug-in function module cards.

Mechanically, Control Processor 214 is a single printed circuit board (pcb) which occupies a dedicated slot 216 in audio CODEC with audio/data communications gateway 100.

Control Processor 214 is essential for the operation of audio CODEC with audio/data communications gateway 100 and therefore must always be present. Consequently, this function module is not hot swap capable. However, Control Processor 214 must interface with the bus circuitry of the optional plug-in cards in the system and therefore interface circuitry of Control Processor 214 is designed to be compatible with the other cards on P-bus 560. These other function module cards are in general hot swap capable and therefore drive the selection of the logic family for P-bus 560 circuitry.

An I/O interface side of Control Processor 214 has a number of connectors. Connectors 246, 248 provide remote control ports. Connector 250 provides an ancillary data interface; and connector 252 provides for an Alarm/Relay interface. Three status LEDs 254 are also provided on this module.

There are two remote control ports 246, 248 on Control Processor 214. Functionally, these two ports are identical. Electrically, one port provides an interface for RS232 connections which is intended for connection to a standard VT-100 style monitor or emulator. This port is configured as a DCE device and is wired to allow for the use of a straight through cable for connection to the standard COM port on a PC. The other remote control port provides an RS485 interface with point-to-point and multidrop capability intended for use in a networked system of mainframes. Both of these ports allow for control of all system functions through the use of a set of remote control commands.

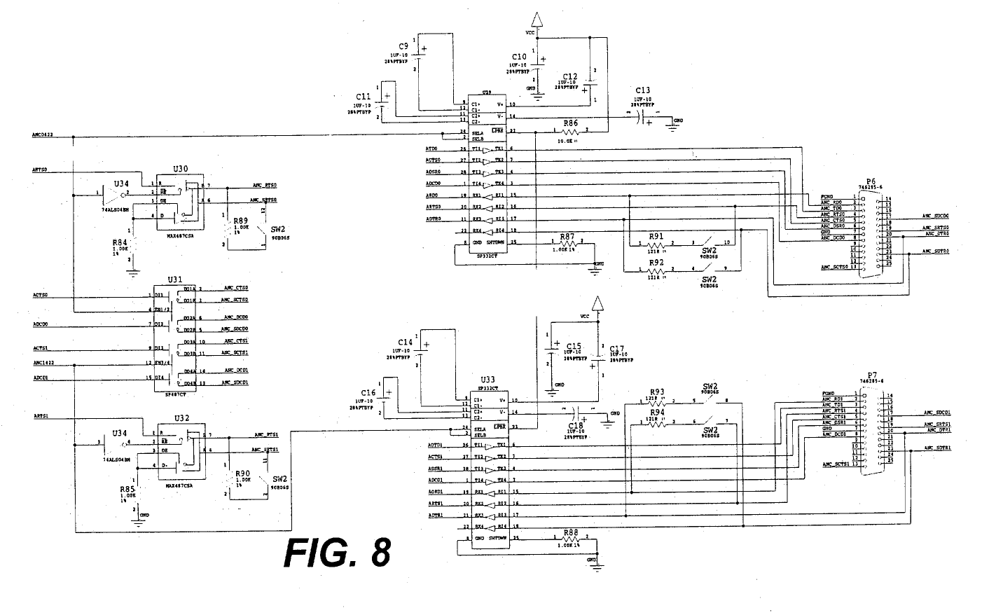

There are two Ancillary data ports 242, 250 available on control processor 214. A detailed circuit diagram of ancillary data circuits 800, 802 of control processor 214 are shown in FIG. 8. Electrically, these two interfaces are identical RS232 style ports configured as a DCE device.

One ancillary data port is directly connected to a serial port of the MPC860 controller of control processor 214. This port can only be used for ancillary data to/from an Encoder/Decoder after first passing through the controller; and can be used in a data multiplexing mode where additional sources of ancillary data are multiplexed with this data; or in a protocol mode where a protocol layer is applied to the data from this port. While it is possible to pass this data unmodified to backplane 500, there is an inherent processing delay in going through the MPC860.

The other ancillary data port has an additional mode which allows it to bypass the controller and be applied directly to one of backplane 500 asynchronous serial channels. This effectively allows a direct connection to an Encoder/Decoder without any processing delay. This port has the same multiplexing capability as the first ancillary data port when it is connected directly to an MPC860 serial port. The switching capability to allow this operation is carried out in hardware on Control Processor 214.

An Alarm/Relay circuit on Control Processor 214 provides both alarm capabilities as well as external control functions. For the alarm capabilities, two sets of relay contacts, an ‘A’ alarm and a ‘B’ alarm, are provided. Each provides a normally closed (NC) and a normally open (NO) set of contacts, plus a common. The normally open contacts serve as the alarm condition since with no power applied to Control Processor 214 this is the default position. In this way a power failure may be signaled as an alarm condition. Other events which can control operation of these relays are under software control. This allows various events in audio CODEC with audio/data communications gateway 100 to be assigned as either A or B level alarms as needed.

For external control functions, sets of single pole—single throw (SPST) dry contacts are provided. These control external devices and signal status conditions of Audio CODEC with audio/data communications gateway 100. As with the alarm relays, these are software controlled and therefore the events to trigger the operation of the relays are programmable.

Also, sets of optically isolated inputs are provided. These allow a user to input control signals into Audio CODEC with audio/data communications gateway 100. The response to these inputs is software controlled.

At the heart of control processor 214 is the MPC860 communication controller. This device provides the processing power required to configure, control, and monitor all functions in Audio CODEC with audio/data communications gateway 100. Along with several types of memory, a reset circuit, and a debug port, it forms the core processor circuit.

System memory for controller processor 214 is divided into three basic types: flash read-only memory (ROM), dynamic random access memory (RAM), and a serial electronically erasable programmable read only memory (EEPROM). The flash memory is divided into two parts: a 512K×8 boot flash ROM device that contains all the code needed to bring Control Processor 214 up to a point which allows it to download a full system code; and a 2M×8 second flash ROM device that contains the system code. Both of the flash ROMs are programmable in-circuit and allow for field upgrades to the software.

The dynamic RAM used in Control Processor 214 is 1M×32 and is used for temporary storage of system variables as well as for executing code. Since this memory is configured as 33 bits wide, its speed is significantly faster than that of the flash memory. Therefore, code execution is done from this memory.

For non-volatile storage of system operating parameters, a serial EEPROM is used. This is a 4K×8 device but is connected to the MPC860 over a serial style I²C port. A copy of a parameter table is kept in RAM during operation and only changes cause the EEPROM to be updated.

A reset circuit of a processor core contains a watchdog timer that resets the MPC860 in the event that code execution becomes disrupted by an error condition. This circuit also provides for smooth power-up of the MPC860 processor during a power-on as well as providing a local switch for resetting control processor function module 214.

Power supply monitor circuitry provides input lines to the MPC860 which pass power supply status condition from backplane 500 to the MPC860 controller. An output voltage to be monitored and the failure of the voltage is passed over backplane 500 to control processor 214. This information can be used to trigger an alarm condition or close relay contacts to signal external equipment.

Status indicators on control processor 214 include two alarm LEDs and a system OK LED.

The alarm LEDs correspond to the Alarm relays described above. An alarm A indicator is a red LED and is illuminated when an alarm condition associated with the A circuit is active. An Alarm B LED is yellow and follows the operation of the Alarm B relay. When a B alarm is present, this LED is illuminated.

A System OK LED is green and is illuminated when control processor 214 is powered on and ready to accept commands through the remote control ports, and is therefore essentially a “system boot in progress” LED.

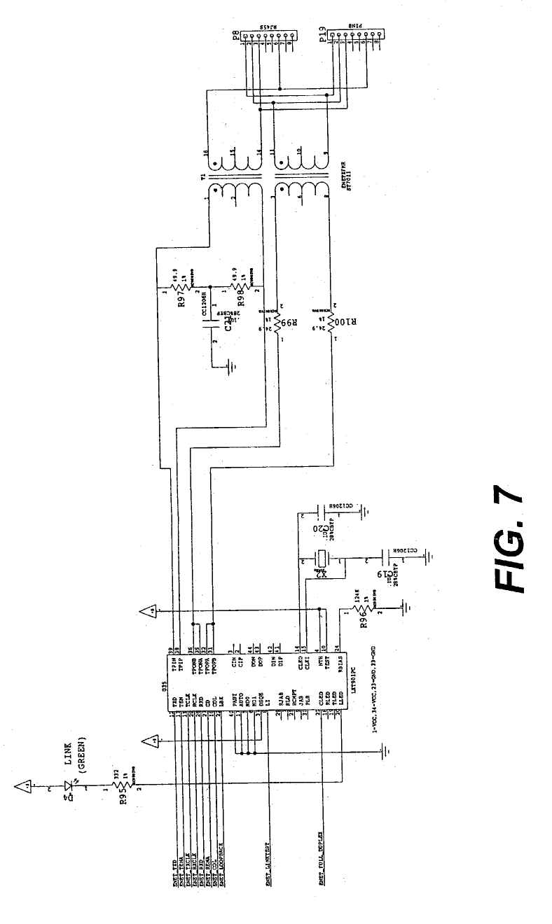

Ethernet connectivity is provided on control processor 214 without need for a further interface card. A detailed circuit diagram of Ethernet interface 700 of control processor 214 is shown in FIG. 7. A 10 base T Ethernet interface allows access to E1 or T1 data and effectively gives data access to the E1 or T1 communication channel through the MPC860. Data is accessed from backplane 500 TDM T-bus 550 by the MPC860 which is then made available through the Ethernet port.

In addition to the Ethernet port, a port is included for connecting a keypad, such as keypad 116, and a visual display panel, such as LCD 113, which allows local control through front panel interface 110 without using remote control port 246.

A connection to headphone jack 128 provides an audio feedback signal for use with an attached headphone (not shown) when using keypad 116 to enter data.

Audio function modules 220, 272, and 284 support conventional ISO/MPEG layer 2, MUSICAM® enhanced ISO/MPEG layer 2, ISO/MPEG layer 3, CCITT G.722, J.41 and J.57 compression algorithms. Audio sampling rates of 16, 24, 32 and 48 kHz are supported and can be selected based on the transmission needs of a particular audio signal. Additionally, full stereo, joint stereo and monaural modes are supported. 24 bit A/D and D/A converters provide digital to analog and analog to digital data conversion. Multiple CODEC 220, encoder 272 and/or decoder modules 284 can be installed thereby enabling transmission or reception of up to four audio channels using up to two different compression algorithms to occur simultaneously. As used hereinafter the term cascading refers to compressing an audio signal multiple times using the same algorithm whereas the term transcoding refers to compressing an audio signal multiple times using different algorithms.

MUSICAM ® enhanced ISO/MPEG layer II and conventional ISO/MPEG layer II are supported at bit rates from 24 to 384 kb/sec and sampling rates of 16 to 48 kHz; and CD-quality stereo audio can be transmitted using as little as 112 kb/sec. As enabled by Audio CODEC with audio/data communications gateway 100 up to 4 unidirectional or bi-directional audio channels can be supported. Enhancements to ISO/MPEG layer II provided by MUSICAM® enhanced ISO/MPEG layer II apply only to the encoder side. Therefore enhanced audio encoded by Audio CODEC with audio/data communications gateway 100 using MUSICAM® enhanced ISO/MPEG layer II can be decoded and reproduced by any ISO/MPEG layer II capable decoder. Enhanced MPEG Layer II can deliver 10.2 kHz monaural audio on one 64 kb/sec channel with 24 kHz sampling; and at 128 kb/sec transparent 20 kHz monaural, near-transparent joint stereo, or 10.2 kHz dual mono (stereo) audio. At bit rates higher than 128 kb/sec transparent joint stereo or stereo with immunity to degradation even after up to 15 cascades (at 384 kb/sec) is provided.

ISO/MPEG layer III can deliver near-CD quality true stereo using as little as 112 kb/sec, and 15 kHz monaural audio using as little as 56 kb/sec. As implemented in Audio CODEC with audio/data communications gateway 100 bit rates of 64 to 320 kb/sec and sampling rates of 24 to 48 kHz are supported. ISO MPEG layer III builds on ISO/MPEG layer II by adding an additional layer of redundancy reduction using entropy encoding. As enabled by Audio CODEC with audio/data communications gateway 100 full duplex, 15 kHz monaural audio can be delivered using one 64 kb/sec channel. At 128 kb/sec transparent 20 kHz monaural audio is possible, with near transparent 20 kHz joint-stereo. In dual mono or stereo modes, near transparent 15 kHz audio is capable at bit rates as low as 128 kb/sec. Audio CODEC with audio/data communications gateway 100 supports ISO/MPEG layer III at bit rates from 64-320 kb/sec and sampling rates of 24, 32 and 48 kHz. Up to 4 one way bi-directional audio channels can be supported.

CCITT G.722 provides full duplex 7.5 kHz audio over a single 56/64 kb/sec channel using conventional adaptive pulse code modulation techniques (ADPCM).

J.57 is a nearly linear compression algorithm that does not depend on redundancy reduction compression techniques. With 24 bit sampling at a 48 kHz sampling rate, block ‘companding’ (compression/expansion), rather than compression, yields compression ratios as low as 1.33:1 at E1 transmission rates. J.57 can withstand multiple encodings and aggressive post-processing, and has extremely short delay. J.57 multiplexes data with the audio and can reformat the AES/EBU formatted stream containing stereo digital audio and embedded data.

The J.41 compression algorithm produces transparent, digital master quality monaural audio using 384 kb/sec per channel (stereo audio at 768 kb/sec). With only a 2:1 compression ratio, low delay and high immunity to cascading and post processing effects can be achieved. The sampling rate is fixed at 32 kHz and the bit rate is fixed at 384 kb/sec per channel. Each audio module can send and/or receive two monaural channels (one stereo program); and 4 bi-directional audio channels can be sent over a single T1 circuit.

Each individual CODEC 220 or encoder 272/decoder 284 pair allows one channel of ancillary data to be multiplexed into the audio bit stream and subsequently demultiplexed at a receiving end. Ancillary data multiplexed by CODEC 220 or by an encoder 272/decoder 284 pair is evenly split between left and right channels to ensure equal fidelity. Additionally, two ancillary data paths are available at connectors 242 and 250 of control processor 214 for use with other algorithms. Bandwidth in an output digital audio data stream associated with ancillary data is allocated to the transmitted data stream on an as-needed basis only. Thus, if no ancillary data is present, no bandwidth capacity is taken from the audio data stream even if Audio CODEC with audio/data communications gateway 100 is configured to send ancillary data.

Encoder function module 272 is a conventional MUSICAM-enhanced stereo audio encoder. The Digital Signal Processing (DSP) circuits of the encoder support compression algorithms including: compatible, MUSICAM-enhanced MPEG Layer 2, MPEG Layer 3, G.722, J.41/J.42 and J.57 algorithms; and support bit rates from 24 through 2.048 Mb/s and sampling rates from 16 through 48 kHz. In addition to the DSP sections, the timing section of encoder function module 272 is based on TDM T-bus 550 interface; and accesses data from TDM T-bus 550 formatting and accepting the data from the encoder in a serial data stream—converting the TDM data into a six channel serial data stream to encoder 272's DSP's.

J.41 and J.42 are audio compression techniques based on 384 Kb/s data streams. J.41 forms a 384 Kb/s stream from a single 32 kHz sampled mono audio channel. The bandwidth of the audio is 15 kHz mono. Two 384 Kb/s streams can be produced simultaneously from a stereo input signal. Each 384 Kb/s stream contains one of the input audio channel. The two streams are routed over the same communication link to ensure identical transmission delays for both streams. The decoder is capable of receiving the two streams and simultaneously decoding the two streams thereby producing audio for a 15 kHz stereo connection.

J.42 forms a 384 Kb/s stream from a 16 kHz sampled stereo audio channel. The bandwidth of the audio is 7 kHz stereo. This is routed through a communication network as an independent stream to a far end decoder. The decoder can then receive this 384 Kb/s stream and produce a 7 kHz stereo signal.

Neither J.41 nor J.42 contain the provision for ancillary data in the 384 Kb/s streams. As a result, when in these modes ancillary data is provided for when running these algorithms on a T1 (E1) network by using a time slot of the T1 (E1) frame; and this functionality is handled by the T1 (E1) multiplexer plug-in function module.

Encoder function module 272 occupies a single slot, such as slot 226, and includes an AES/EBU digital audio interface as well as conventional analog inputs.

Decoder function module 284 is a conventional MUSICAM-enhanced stereo audio decoder whose DSP section supports the same algorithms as encoder 272. In addition to the DSP sections, the timing section of decoder 284 is based on TDM T-bus 550 interface; and accesses data from TDM T-bus 550 and formats and passes the data to decoder 284's DSP's as a six channel serial data stream.

Decoder 284 occupies a single slot and includes an AES/EBU digital audio interface as well as conventional analog inputs.

CODEC function module 220 combines the features of encoder function module 272 and decoder function module 284 into a combined module that occupies only one card slot.

E1 multiplexer 296 and T1 multiplexer 298 are similarly configured single-slot plug-in cards that provide the multiplexing and interface functions for E1 and T1 networks, respectively.

E1 multiplexer 296 and T1 multiplexer 298 each have three main port interfaces to backplane 500. These are the TDM bus port, the system timing port, and the processor control port. On the network side, as shown in FIGS. 2e-2f, E1 multiplexer 296 and T1 multiplexer 298, respectively, provides access to three E1 or T1 circuits: main E1 or T1, drop/insert E1 or T1, and E1 or T1 clock. Each of these connections uses a standard 120 ohm symmetrical interface.

Mechanically, E1 function module 296 and T1 function module 298 are each a plug-in circuit board that occupies one slot, such as slot 224, in Audio CODEC with audio/data communications gateway 100. The mechanical interface to the Audio CODEC with audio/data communications gateway 100 backplane 500 is a single 96 pin connector which is hot swap capable. The circuitry of E1 function module 296 and T1 function module 298 can power up with minimum inrush current and is configured in a passive state waiting for instructions from Control Processor 214 for set up information before becoming active.

Main E1 interface 2902 and T1 interface 2922 are the respective primary network interface. Data traffic from Audio CODEC with audio/data communications gateway 100 backplane's TDM T-bus along with data from corresponding drop/insert interfaces 2904, 2924 and the User Data Ports (E1: 2918, 2920; T1: 2938, 2940) are multiplexed onto the primary E1 or T1 interface.

E1 drop/insert connection 2904 and T1 drop/insert connection 2924 are, respectively, also bi-directional E1 and T1 connections for data transfer. E1 multiplexer 296 and T1 multiplexer 298 have the capability of performing a drop/insert function with the data traffic to/from the respective main E1 and T1 network interface 2902 and 2922. While the intended function of these interfaces are drop/insert, the respective electrical interface is a standard E1 or T1. E1 multiplexer 296 and T1 multiplexer 298, respectively, also allow these ports to operate as a fully functional E1 or T1 interface. Thus, E1 multiplexer 296 and T1 multiplexer 298 each effectively has two interfaces which can be operated as fully independent interfaces, each carrying payload data to/from Audio CODEC with audio/data communications gateway 100. Accordingly, the distinction between the drop/insert interfaces and the main channel interfaces is somewhat artificial.

E1 timing interface 2908 and T1 timing interface 2928, respectively, allow connection to an active E1 or T1 circuit. No data is transferred over these interfaces. These interfaces are used strictly to derive a network timing signal from a connected network. This includes both bit clock as well as frame sync information; and is a receive only interface.

Each of E1 multiplexer 296 and T1 multiplexer 298 have a pair of identical user data ports (E1: 2918, 2920; T1: 2938, 2940) that can be configured either as V.35 synchronous data ports or V.24 asynchronous data ports.

The V.35 synchronous data ports operate at N×64 Kb/s data rates. The data for these ports is retrieved or inserted from any active E1 or T1 time slot or the TDM T-bus's time slots. Since the data and clock are provided at the port as a continuous stream, a FIFO circuit is used to perform the smoothing function. Byte alignment and timing are preserved through this process since these ports provide byte synchronization. Since Audio CODEC with audio/data communications gateway 100 is considered a DCE device in its operation, the V.35 ports always operate as the clock master and these ports do not accept an input clock from any external devices.

The V.24 Asynchronous data ports are variable rate, RS232 style interfaces with standard RS232 levels. The rates vary up to a maximum of 19.2 Kbps. The data stream is over sampled at 21 kHz and the over sampled data is distributed into the T1 (E1) frame. This is a bi-directional port, so data is also pulled out and down converted to the output asynchronous stream.

The TDM bus interface connects two bi-directional 2.048 Mbs E1 or two bi-directional 1.544 Mbs T1 data streams from a cross connect switch to the Audio CODEC with audio/data communications gateway 100's high speed backplane TDM T-bus 550. Information on slot allocation between the TDM T-bus time slots and the time slots on the dual 2.044 or 1.544 Mbs streams is contained locally in the TDM circuitry and is set by Control Processor 214 directly using a P-bus port.

Control

The T1 (E1) multiplexer 218 is a micro-controller based design for controlling all on board functions and monitoring the operation of the card. Board configuration as well as monitoring functions are communicated between this on board processor and Control Processor 214 using two different ports. Either an asynchronous serial back plane port or an 8 bit parallel port can be used. The serial port is currently configured to operate at 9600 baud although other rates are possible.

For the asynchronous serial port (RS232), a command language for inter-processor communication is structured along the lines of an AT style command set. The serial port is used to set the T1 (E1) multiplexer 218's configuration. Status information and alarms are passed over this port to Control Processor 214. The T1 (E1) 218's controller circuit is Flash based and provides software download capability from Control Processor 214 over this serial port.

In addition to the serial port, an 8 bit parallel processor port (P-bus 560) also connects the T1 (E1) multiplexer 218 to Control Processor 214. The main purpose of this port is to set up certain on board multiplexer hardware functions such as the TDM bus interface circuitry. This parallel port is memory mapped in Control Processor 214's memory space.

A system reset line (RESET) is provided as a master reset for the T1 (E1) multiplexer 218 card as well as all other function modules that connect to Audio CODEC with audio/data communications gateway 100's back plane. A local reset through P-bus 560 port allow for individual reset of any particular T1 (E1) card.

System Timing

The T1 (E1) multiplexer 218 is configurable either for internal or external timing relative to timing of an attached network. In the internal timing mode the T1 (E1) multiplexer is synchronized to an internal clock rather than to a network clock. This can be from either of two sources. The T1 (E1) multiplexer has an on board crystal oscillator from which it can derive its timing; or it can use a system clock (SYSCLK).

In the external timing mode, which generally is a preferred operating mode for the card, timing is derived from the attached external network. This clock is recovered from one of the three T1 (E1) ports. The T1 (E1) timing port 276 is used solely for this purpose and is not capable of carrying data. Either the T1 (E1) drop/insert 268 and the T1 (E1) main 260, which are electrically identical, can also be used to derive the network clock for synchronization.

A timing generator circuit selects the appropriate clock source for synchronization and derives all the necessary clocks for the multiplexer card's internal operation. If the multiplexer is the timing master, it also drives the master clock (MCLK) and time slot 0 transmit and receive (TSO and RSO) clocks. These signals are used to derive timing for the TDM back plane bus. If the multiplexer is configured as a system timing slave then these lines are tri-stated since the timing signal is sourced from somewhere else. The slave mode is a default power up condition to prevent bus contention when the multiplexer board is installed or reset.

Cross Connect Switch (Multiplexer Operation)

A cross connect switch on T1 (E1) multiplexer 218 is the circuitry which provides the multiplexing function for the card. There are effectively seven, 1.544 Mbs T1 (2.048 Mbs E1), bid-directional channels into the switch matrix. Each channel has a time slot structure which matches the T1 (E1) frame structure. The switch has the capability of routing any time slot from any channel to any other time slot of any other channel.

A connection table is maintained by the multiplexer's on board micro-controller section which receives its instructions from Control Processor 214.

Power Requirements

The T1 (E1) multiplexer 218 operates from a single +5VDC source provided over the back plane. The maximum current draw from this supply is limited to 1 A. In addition, circuitry is provided to minimize inrush current during hot swap operation such that no other system components are affected by the installation or removal of this card.

Status Indicators

The T1 (E1) multiplexer 218 has five LED displays 260, 262, 264, 266, 270, 272 for status indications. These displays include one each for system clock master, synchronization, AIS receipt, TXD, and RXD.

X.21 Interface

X.21 function module (not shown) provides all the necessary interface functions to allow access to the TDM bus on backplane 500 over a standard X.21 electrical interface. The data accessed from the TDM bus is programmable and on board circuitry insures that the data stream is continuous.

There are two DB 15 female connectors used for the output of the X.21 module. These two connectors are equivalent, both electrically as well as physically.

Communications between E1 multiplexer 296 or T1 multiplexer 298 and Control Processor 214 is via an asynchronous serial port for passing commands and a memory mapped control register port to set control bits and read back status information.

Control Processor 214 communicates commands to the T1 (E1) multiplexer 218 using a standard serial port interface of backplane 500. The communication protocol, or command set, is based on the AT style command set.

Audio CODEC with audio/data communications gateway 100 is configured from interface panel 110 by using visual display panel 112, navigation wheel 114, keypad 116, dial keys 118, function keys 120, and VU meters 124; and will be described in greater detail below. Using an integral RS232 compatible interface system, programming and operations can also be remotely controlled. Additionally, system software can be updated through the RS232 interface. When using an external terminal or computer, an on-line help feature is also provided.

User interface panel 110 includes an internal keypad beeper (not shown) which can be turned on and off by the user; and when on gives a positive audible feedback signal to the user whenever a button of keypad 116 is pressed. Additionally, a contrast of visual display panel 112 can be adjusted by the user.

Navigation switch wheel 114 controls movement of cursor bars 302, 302′ on display panel 112. Pressing up arrow 316 moves cursor bars 302, 302′ upward and is also used to move up to a higher level of a configuration menu tree. Position 316 can also be used during power-on to force audio CODEC with audio/data communications gateway 100 to enter into a ROM boot mode. Pressing down arrow 318 moves cursor bars 302, 302′ downward and is also used to step down to a next lower menu level in the configuration menu and to accept a currently displayed menu option value. Pressing right arrow 320 moves cursor bars 302, 302′ to the right and is also used to advance to a next item in the configuration menu; and pressing left arrow 322 moves cursor bars 302, 302′ to the left and is also used to step back to a previous item in the configuration menu.

Alphanumeric keypad 116 can be used to enter all information required for execution of commands as well as for dialing. Dial function keys 118 include a dial key 118′, speed-dial key 118″, speed-dial directory key 118″″, and a hangup key 118″″. Selecting dial key 118′ allows direct dialing of one or more ISDN b-channels when an ISDN terminal adapter, such as terminal adapter 222, is installed. Selecting speed-dial key 118″ enables selection of one of 256 pre-programmed speed-dial directory addresses. All parameters describing the connection are stored in each speed dial address. Selection of speed-dial directory key 118′″ provides access to the speed dial directory for adding, deleting or changing entries. Selection of hangup key 118″″ terminates an ISDN connection established with dial key 118′ or speed-dial key 118″.

Headphone jack 128 and VU meter 124 monitoring of an audio signal quality requires selection of an audio module to be monitored. Since any of slots 224, 226, 228 can contain any type of function module, function keys 120 are used to select which audio module expansion slot (three keys, one each corresponding to slots 224, 226, 228) is to be monitored. When the selected audio module is a bi-directional CODEC, the fourth key of the group of function keys, labelled 120, i.e. the one on the bottom position, selects whether the transmitted or received audio is to be monitored. A corresponding one of LEDs 122 illuminates when a function key 120 is selected.

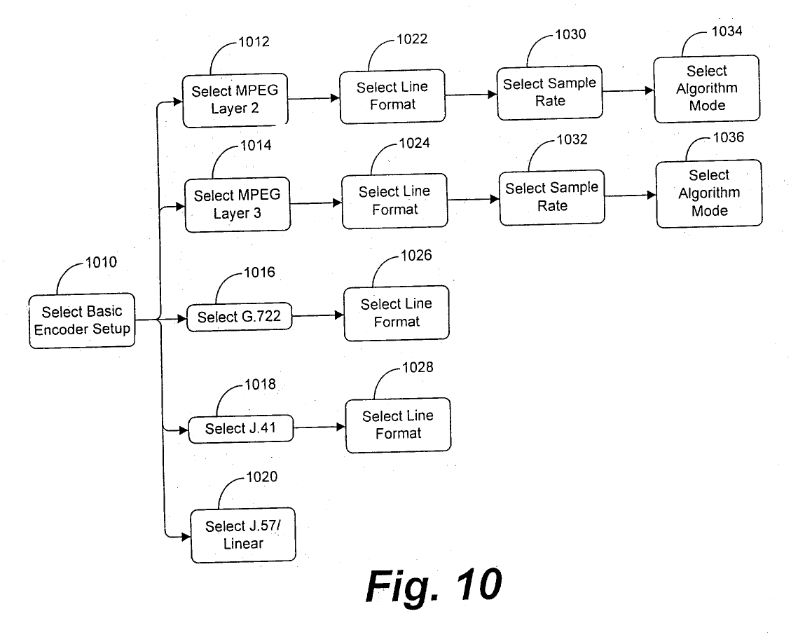

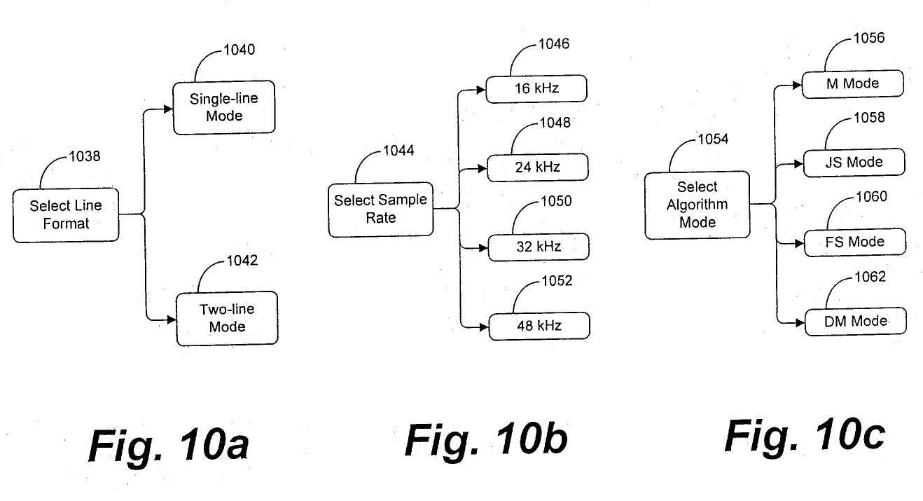

The Select Basic Encoder Setup 1010 of FIG. 10 is used to select the algorithm, and where appropriate, line format, sample rate, and mode. The Encoder Setup mode is entered by selecting a slot that contains an encoder or codec module. The Encoder is configured in a ‘top-down’ fashion, selecting parameters in order. The first step is selecting the algorithm. The algorithms that can be selected include MPEG Layer 2 1012, MPEG Layer 3 1014, G.722 1016, J.41 1018, and J.57/Linear 1020. Depending on the algorithm selected, you then ‘step-through’ other settings, such as Line Format 1022, 1024, 1026, 1028, Sample Rate 1030, 1032, and Algorithm Mode 1034, 1036 (MPEG algorithms only). With all algorithms that offer choices of bit rate, the rate is selected when configuring the network connection. When using a remote control, the EAL command is used to select the algorithm.

As shown by FIGS. 10 and 10a, the next step after the algorithm is selected is selecting the Line Format 1038. Most available algorithms allow more than one line format. The line format determines the number of ‘lines’, i.e. digital channels, used to connect to another codec. If the Single-line Mode 1040 is selected, a single digital ‘pipe’ connects the two codecs. The pipe can be at any rate (multiple of 64 kb/s) between 64 kb/s and a full E1 (2,054 kb/s). The Single-line Mode is supported by all algorithms. If the Two-line Mode 1042 is selected, the signal is split equally between two digital lines. This mode is only supported by MPEG algorithms, is used mostly for ISDN BRI Connections, and uses both ‘B’ channels, and only supports connect rates of 112 or 128 kb/s. If the independent mono format is selected, two available lines are used to send two different audio channels to two different locations (or stereo to one location). This mode is supported with G.711 and J.41. The encoder line format must be the same as the far-end decoder line format. When using a remote control, the ELI command is used to select the line format.

As shown by FIGS. 10 and 10b, the nest step after the Line Format 1038 is selected is selecting the encoder Sample Rate 1044. The encoder Sample Rate 1044 is the rate the audio is sampled for conversion by the encoder. The sample rates which can be selected include 16 kHz 1046, 24 kHz 1048, 32 kHz 1050, and 48 kHz 1052. When using a remote control, the ESR command is used to select the sample rate.

As shown by FIGS. 10 and 10c, the next step after the encoder Sample Rate 1044 is selected is selecting the Algorithm Mode 1054, for those algorithms that have a choice (i.e. MPEG algorithms). The Algorithm Modes 1054 which can be selected include M Mode 1056, JS Mode 1058, FS Mode 1060, and DM Mode 1062. When using a remote control, the EAM command is used to select the Algorithm Mode 1054.

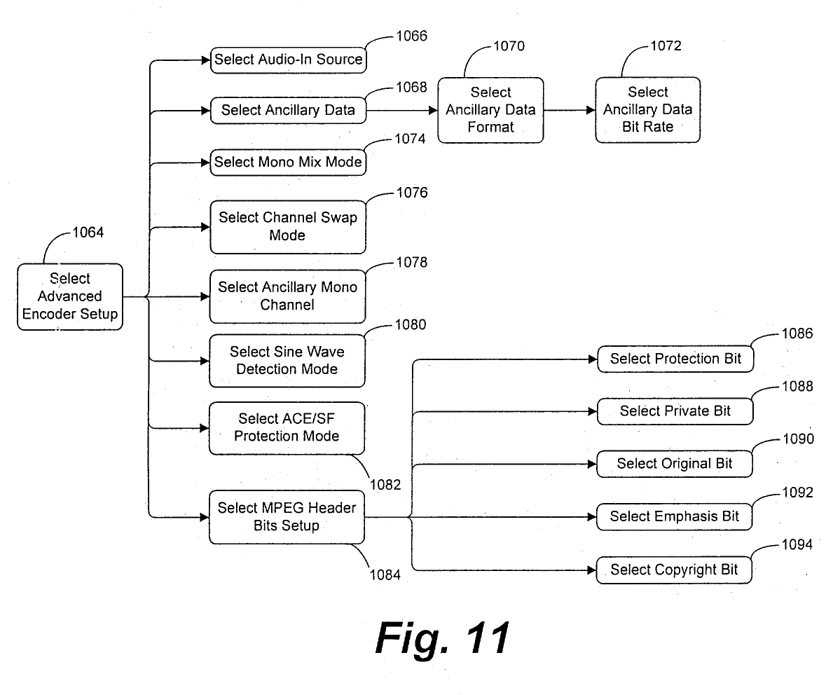

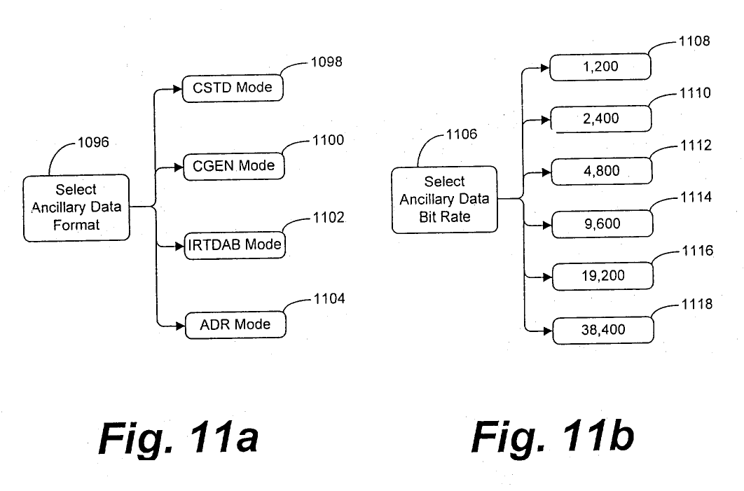

The Select Advanced Encoder Setup 1064 is shown by FIG. 11. The Advanced Encoder Setup 1064 is entered by selecting an encoder module (either SL-E or SL-ED).

As shown by FIG. 11, the first selection which can be made using the Advanced Encoder Setup 1064 is the Audio-In Source 1066. This function is used to select either analog or digital audio inputs.

As further shown by FIGS. 11 and 11a, the next selections which can be made using the Advanced Encoder Setup 1064 involve the Ancillary Data 1068. MPEG algorithms allow ancillary data to be multiplexed with audio data. Accordingly, this selection is not available when non-MPEG algorithms have been selected. The first step is selecting the Ancillary Data Format 1070. The Ancillary Data Formats 1096 which can be selected include CSTD Mode 1098, CGEN Mode 1100, IRTDAB Mode 1102, and ADR Mode 1104. After the Ancillary Data Format 1070 is selected, the Ancillary Data Bit Rate 1072 is selected. The available Ancillary Data Bit Rates 1106 which can be selected include 1,200 1108, 2,400 1110, 4,800 1112, 9,600 1114, 19,200 1116, and 38,400 1118.

As further shown by FIG. 11, the next selection which can be made using the Advanced Encoder Setup 1064 is the Mono Mix Mode 1074. The Mono Mix Mode 1074, which is available with any algorithm, allows the left and right audio input channels to be mixed down to mono.

As further shown by FIG. 11, the next selection which can be made using the Advanced Encoder Setup 1064 is the Channel Swap Mode 1076. The Channel Swap Mode 1076, which is available with any algorithm, allows the left and right input channels to be swapped. Since mono algorithms or modes normally used the left audio input, this function allows you to switch between two audio sources.

As further shown by FIG. 11, the next selection which can be made using the Advanced Encoder Setup 1064 is the Ancillary Mono Channel 1078. The Ancillary Mono Channel 1078 allows you to specify which channel to use for ancillary data when using an independent mono line format to send J.41 audio to two locations.

As further shown by FIG. 11, the next selection which can be made using the Advanced Encoder Setup 1064 is the Sine Wave Detection Mode 1080. The Sine Wave Detection Mode 1080, which is only available when the MPEG Layer 2 algorithm is selected, should only be used when using test tones for audio analysis with test equipment, and should be OFF for normal operation.

As further shown by FIG. 11, the next selection which can be made using the Advanced Encoder Setup 1064 is the ACE/SF (Advanced Concealment of Errors/Scale Factors) Protection Mode 1082. The ACE/SF Protection Mode 1082 is only available when the MPEG Layer 2 algorithm is selected. The ACE is based on CRC protection of the ISO/MPEG Layer 2 scale factors. In general, it is better to use scale factor protection if the data channel is noisy (high BER). Scale factors are the levels of the digital audio signal within a sub-band. There are 32 sub-bands and the scale factors change the level over a 120 dB range. An error on any scale factor will cause a perceptible impairment in the audio. Scale factor protection is not bi-directional and must be enabled independently for each direction. If only one end has scale factor protection enabled, audio may be muted.

As further shown by FIG. 11, the next selection which can be made using the Advanced Encoder Setup 1064 is the MPEC Header Bits Setup 1084. The MPEG Header Bits Setup 1084 is only available when an MPEG algorithm is selected. The MPEG algorithm allocates five user definable header bits, used for signaling purposes, which can be selected. These five bits include a Protection Bit 1086 (EPR), Private Bit 1088 (EPI), Original Bit 1090 (EOR), Emphasis Bit 1092 (EEP), and Copyright Bit 1094 (ECR).

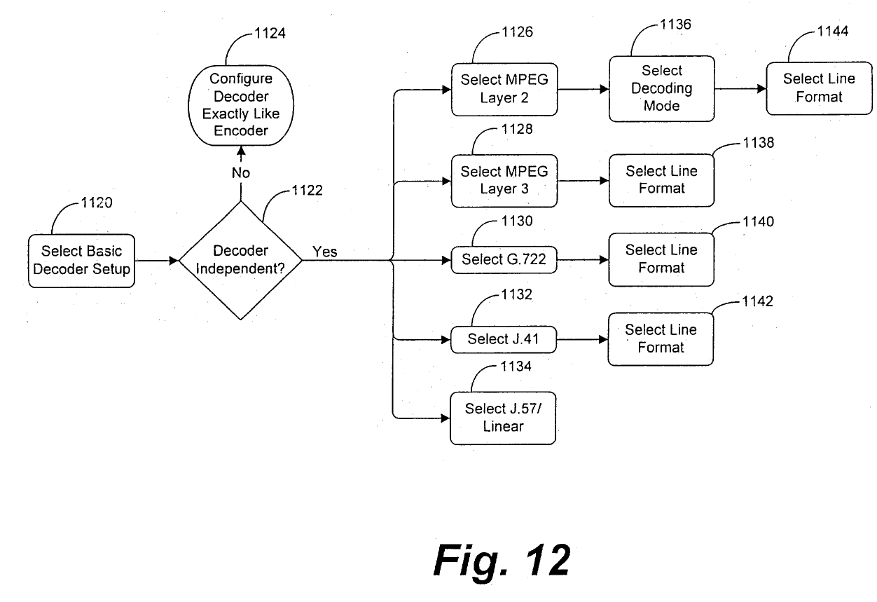

The Select Basic Decoder Setup 1120 of FIG. 12 is used to select the algorithm, and where appropriate, line format and mode for the decoder. Once the Basic Decoder Setup 1120 is entered, the first step is selecting whether the Decoder is Independent 1122. If an independent decoder is not selected, the Decoder is Configured Exactly Like the Encoder 1124, and is slaved to the incoming bit stream. If an independent decoder is selected, it will allow send and receive audio to use different algorithms.

If an independent decoder is selected, the next step is selecting the algorithm. The algorithms that can be selected include MPEG Layer 2 1126, MPEG Layer 3 1128, G.722 1130, J.41 1132, and J.57/Linear 1134. Depending on the algorithm selected, you then ‘step-through’ other settings, such as Line Format 1144, 1138, 1140, 1142 and Decoding Mode 1136 (MPEG Layer 2 1126 algorithm only).

As further shown by FIG. 12, if the MPEG Layer 2 1126 algorithm is selected, the next step is selecting the Decoding Mode 1136. The available Decoding Modes 1136 for selection include ISO and ISO/CCS.

As further shown by FIG. 12, the next step is selecting the Line Format 1144, 1138, 1140, 1142. The available Line Formats 1144, 1138, 1140, 1142 for selection include single line, 2-line, and independent mono.

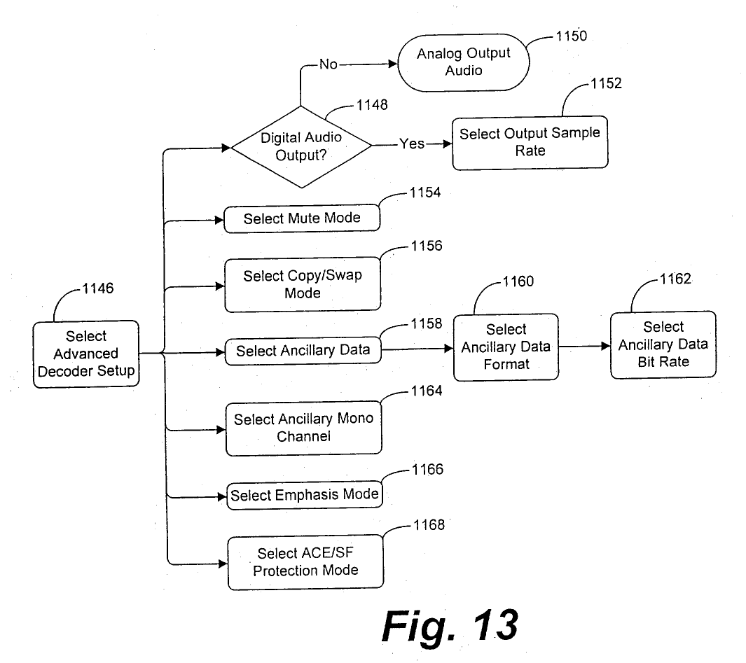

The Select Advanced Decoder Setup 1146 is shown by FIG. 13.

As shown by FIG. 13, the first selection which can be made using the Advanced Decoder Setup 1146 is the Digital Audio Output 1148. This function is used to select either Analog 1150 or digital Audio Output. Digital audio output is not supported when using the G.722 algorithm. If Digital Audio Output is selected, the next selection is the Output Sample Rate 1152. The available Output Sampling Rates 1152 for selection include 32 kHz or 48 kHz. Once the Output Sampling Rate 1152 is selected, the next selection is whether to use internal or external synchronization.

As further shown by FIG. 13, the next selection which can be made using the Advanced Decoder Setup 1146 is the Mute Mode 1154. The Mute Mode 1154 is used to mute the audio output. Left and right channels can be muted independently or together.

As further shown by FIG. 13, the next selection which can be made using the Advanced Decoder Setup 1146 is the Copy/Swap Mode 1156. The Copy/Swap Mode 1156 allows the left channel audio to be copied over the right channel or the right channel audio to be copied over the left channel. The Copy/Swap Mode 1156 also allows the left and right channels to be swapped. This mode is useful when using the independent mono operation for switching between programs.

As further shown by FIG. 13, the next selection which can be made using the Advanced Decoder Setup 1146 involve the Ancillary Data 1158. MPEG algorithms allow ancillary data to be multiplexed with audio data. Accordingly, this selection is not available when non-MPEG algorithms have been selected. The first step is selecting the Ancillary Data Format 1160. The Ancillary Data Formats 1160 which can be selected include CSTD Mode, CGEN Mode, IRTDAB Mode, and ADR Mode. After the Ancillary Data Format 1160 is selected, the Ancillary Data Bit Rate 1162 is selected. The available Ancillary Data Bit Rates 1162 which can be selected range from 300 to 38,400.

As further shown by FIG. 13, the next selection which can be made using the Advanced Decoder Setup 1146 is the Ancillary Mono Channel 1164. The Ancillary Mono Channel 1164, available when using MPEG algorithms with independent mono line format, makes it possible to receive audio and ancillary data from two different locations. The Ancillary Mono Channel 1164 is used to define from which channel, or location, to decode the ancillary data.

As further shown by FIG. 13, the next selection which can be made using the Advanced Decoder Setup 1146 is the Emphasis Mode 1166. The Emphasis Mode 1166 is used to set the decoder emphasis when using the J.41 algorithm.

As further shown by FIG. 13, the next selection which can be made using the Advanced Decoder Setup 1146 is the ACE/SF Protection Mode 1168. The ACE/SF Protection Mode 1168 is only available when the MPEG Layer 2 algorithm is selected. The ACE/SF Protection Mode 1168 sets scale factor protection which can improve the audio transmission quality when in the presence of a noisy connection. Scale factor protection is not bi-directional and no audio is output if the settings are not the same as the far-end encoder.

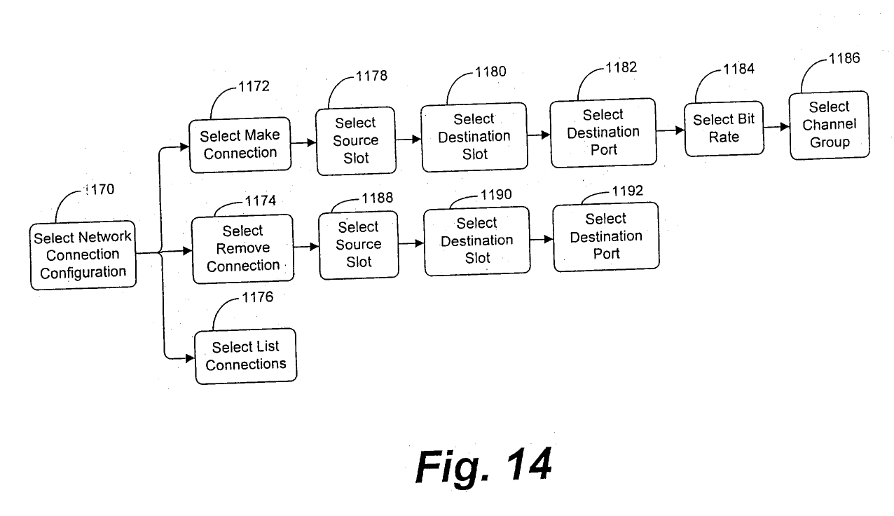

The Select Network Connection Configuration 1170 is shown by FIG. 14.

As shown by FIG. 14, the first selection which can be made using the Network Connection Configuration 1170 is whether to Make a Connection 1172, Remove a Connection 1174, or List the Connections 1176. The available connections include E1, T1, ISDN, X.21, and V.35. For an E1 connection, which supports thirty-two 64 kb/s timeslots, when streaming audio, a Control Processor is considered a destination. For an ISDN connection, the terminal adapter(s) must be configured for the local ISDN.

As further shown by FIG. 14, once the Make Connection 1172 is selected, the next selection is to select the Source Slot 1178, followed by a selection of the Destination Slot 1180, the Destination Port 1182, the Bit Rate 1184, and finally the Channel Group 1186.

As further shown by FIG. 14, once the Remove Connection 1174 is selected, the next selection is to select the Source Slot 1188, followed by a selection of the Destination Slot 1190, and finally the Destination Port 1192.

The present invention has now been described with respect to a selected embodiment thereof. However, other embodiments would be obvious to those skilled in the art without departing from the spirit and scope of the appended claims.

We claim:

1. A hot-swappable audio and data communications gateway apparatus comprising:
a housing;
an integral interface panel carried by said housing, said interface panel adapted to display a configuration parameter option to a user and to receive a corresponding configuration parameter option setting from the user;
a plurality of slots in said housing, each having a corresponding external access opening adapted to receive a selected one of a plurality of function modules, wherein at least one of said plurality of function modules is hot swappable through a port into a bus;
a control processor circuit card insertable into a first one of said plurality of slots; and
a configuration software program stored on said control processor circuit card, said configuration program adapted to identify at least one of said plurality of function modules inserted into another of said plurality of slots, and to provide a corresponding configuration menu having said configuration parameter option to said interface panel, and to receive said corresponding configuration parameter option setting from said interface panel.

2. The apparatus as claimed in claim 1, wherein said selected one of said plurality of function modules is a CODEC.

3. The apparatus as claimed in claim 2 wherein said CODEC has a plurality of programmed compression/decompression schemes.

4. The apparatus as claimed in claim 1, wherein said selected one of said plurality of function modules is an encoder.

5. The apparatus as claimed in claim 4 wherein said encoder has a plurality of programmed compression schemes.

6. The apparatus as claimed in claim 1, wherein said selected one of said plurality of function modules is a decoder.

7. The apparatus as claimed in claim 6 wherein said decoder has a plurality of programmed decompression schemes.

8. The apparatus as claimed in claim 1 wherein said selected one of said plurality of function modules is a T1 multiplexer, or an E1 multiplexer, or an ISDN interface, or an X.21 interface, or a V.35 interface.

9. The apparatus as claimed in claim 1, wherein said interface panel further comprises a visual display panel.

10. The apparatus as claimed in claim 1, wherein said interface panel further comprises a navigation control.

11. The apparatus as claimed in claim 10, wherein said navigation control is a circular navigation switch wheel.

12. The apparatus as claimed in claim 1, wherein said interface panel further comprises at least one VU meter.

13. The apparatus as claimed in claim 1, wherein said interface panel further comprises an alpha-numeric keypad.

14. The apparatus as claimed in claim 1, wherein said interface panel further comprises a plurality of programmable function keys.

15. The apparatus as claimed in claim 1 further comprising a user-configurable hardware interface.

16. The apparatus as claimed in claim 15, wherein said apparatus is configurable as a CODEC.

17. The apparatus as claimed in claim 15, wherein said apparatus is configurable as a linear uncompressed STL.

18. The apparatus as claimed in claim 17, wherein said apparatus further comprises a built-in ISDN backup.

19. The apparatus as claimed in claim 15, wherein said apparatus is configurable as a network audio server.

20. The apparatus as claimed in claim 19, wherein said network audio server outputs a streaming audio output signal.

21. The apparatus as claimed in claim 20, wherein said streaming audio output signal is adapted to a multi-format.

22. The apparatus as claimed in claim 20, wherein said streaming audio output signal is output to a network.

23. The apparatus as claimed in claim 15, further comprising Advanced Audio Coding.

24. The apparatus as claimed in claim 23, wherein said Advanced Audio Coding is adapted to provide a stereo output signal on a single ISDN B channel.

25. An interconnected first hot swappable audio and data communications gateway apparatus and a second hot swappable audio and data communications gateway apparatus, each comprising:
an interface panel adapted to display a configuration parameter option to a user and to receive a corresponding configuration parameter option setting from a user;
at least one of a plurality of function modules, wherein at least one of said plurality of function modules is hot swappable through a port into a bus;
a control processor circuit card;
a configuration software program stored on said control processor circuit card, said configuration program adapted to identify said at least one of said plurality of function modules, and to provide a corresponding configuration menu having said configuration parameter option to said interface panel, and to receive said corresponding configuration parameter option setting from said interface panel;
a first input for inputting an input signal;
a first output for outputting an output signal, the output signal being related to the input signal according to said selected one of said plurality of function modules and said corresponding configuration parameter option setting.

26. The interconnected first and second apparatus as claimed in claim 25, wherein the input signal to said first audio and data communications gateway apparatus can be encoded and the output signal from said first audio and data communications gateway apparatus can be streamed over a network.

27. The interconnected first and second apparatus as claimed in claim 25, wherein said corresponding configuration parameter option setting of said second apparatus can be remotely controlled over a network by the user of said first apparatus.

28. A method of streaming an audio signal over a network comprising:
providing an input audio signal to a hot swappable audio and data communications gateway apparatus;
providing an output signal from the audio and data communications gateway apparatus to a network media server;
transmitting the signal provided to the network media server over the network; and
receiving the transmitted signal;
wherein said hot swappable audio and data communications gateway apparatus comprises:
a housing;
an integral interface panel carried by said housing, said interface panel adapted to display a configuration parameter option to a user and to receive a corresponding configuration parameter option setting from the user;
a plurality of slots in said housing, each having a corresponding external access opening adapted to receive a selected one of a plurality of function modules, wherein at least one of said plurality of function modules is hot swappable through a port into a bus;
a control processor circuit card insertable into a first one of said plurality of slots; and
a configuration software program stored on said control processor circuit card, said configuration program adapted to identify at least one of said plurality of function modules inserted into another of said plurality of slots, and to provide a corresponding configuration menu having said configuration parameter option to said interface panel, and to receive said corresponding configuration parameter option setting from said interface panel.

29. The method as claimed in claim 28 further comprising:
encoding the input audio signal provided to the audio and data communications gateway apparatus; and
decoding the received transmitted signal.

30. A method of configuring a hot swappable audio and data communications gateway apparatus having an integral interface panel adapted to display a configuration parameter option to a user and to receive a corresponding configuration parameter option setting from a user, comprising the following steps:
providing a control processor circuit card inserted into a first one of a plurality of slots in said apparatus;
providing a configuration software program stored on said control processor circuit card, said configuration software program adapted to identify at least one of a plurality of function modules inserted into another of said plurality of slots;
providing a selected first one of said at least one of said plurality of function modules inserted into said another of said plurality of slots;
selecting said selected first one function module to be configured;
providing a configuration menu to said interface panel corresponding to said selected first one function module, said configuration menu having said configuration parameter option;
displaying said configuration menu on a visual display carried by said interface panel;
navigating through said configuration menu by selectively manipulating a navigation control thereby displaying said configuration parameter option on said visual display; and
entering said corresponding configuration parameter option setting into said interface panel.

31. The method as claimed in claim 30 further comprising:
selecting another of said plurality of function modules inserted into a further one of said plurality of slots;
selecting said another function module to be configured;
displaying a further configuration menu on said visual display;
navigating through said further configuration menu by selectively manipulating said navigation control.

32. The method as claimed in claim 30 further comprising booting said apparatus from a power-off state.

33. The method as claimed in claim 30 further comprising hot swapping said selected first one and a selected second one of said plurality of function modules through a port into a bus.

34. The method as claimed in claim 33 further comprising:
removing said selected first one function modules from said apparatus during a power-on state; and
inserting said selected second one of said plurality of function modules into said apparatus during the power-on state.

35. The method as claimed in claim 33 further comprising:
inserting said selected first one of said plurality of function modules into said apparatus during the power-on state.

36. A hot swappable audio and data communications gateway apparatus comprising:
a housing having a front end and a back end;
an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel;
a first slot in said back end of said housing having a corresponding external access opening;
a plurality of additional slots in said back end of said housing, each of said additional slots having a corresponding external access opening adapted to receive a selected one of a plurality of function modules, wherein at least one of said plurality of function modules is hot swappable through a port into a bus;
a control processor circuit card insertable into said first slot; and
a configuration software program stored on said control processor circuit card, said configuration program adapted to identify at least one of said plurality of function modules inserted into one of said plurality of additional slots, and to provide a corresponding configuration menu having said configuration parameter option to said interface panel, and to receive said corresponding configuration parameter option setting from said interface panel.

37. The apparatus as claimed in claim 36, wherein said plurality of function modules are selected from the group consisting of an encoder module, a decoder module, a full bid-directional CODEC module, an ISDN terminal adapter, a T1 multiplexer, an E1 multiplexer, a V.35 digital interface module, and an X.21/RS422 digital interface module.

38. A hot swappable audio and data communications gateway apparatus comprising:
a housing having a front end and a back end;
an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel;
a first slot in said back end of said housing having a corresponding external access opening;
three additional slots in said back end of said housing, each of said additional slots having a corresponding external access opening adapted to receive a selected one of a plurality of function modules, wherein at least one of said plurality of function modules is hot swappable;
a control processor circuit card insertable into said first slot; and
a configuration software program stored on said control processor circuit card, said configuration program adapted to identify at least one of said plurality of function modules inserted into one of said three additional slots, and to provide a corresponding configuration menu having said configuration parameter option to said interface panel, and to receive said corresponding configuration parameter option setting from said interface panel.

39. The apparatus as claimed in claim 38, wherein said plurality of function modules are selected from the group consisting of an encoder module, a decoder module, a full bid-directional CODEC module, an ISDN terminal adapter, a T1 multiplexer, an E1 multiplexer, a V.35 digital interface module, and an X.21/RS422 digital interface module.

40. A hot swappable audio and data communications gateway apparatus comprising:
a housing having a front end and a back end;
an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel;
a first slot in said back end of said housing having a corresponding external access opening;
a second, third, and fourth slots in said back end of said housing, each of said second, third, and fourth slots having a corresponding external access opening;
a control processor circuit card inserted into said first slot;
a T1 multiplexer module inserted into said second slot;
a full bi-directional CODEC module inserted into said third slot;
an ISDN terminal adapter module inserted into said fourth slot; and
a configuration software program stored on said control processor circuit card, said configuration program adapted to identify at least one of said modules inserted into one of said second, third, and fourth slots, and to provide a corresponding configuration menu having said configuration parameter option to said interface panel, and to receive said corresponding configuration parameter option setting from said interface panel;
wherein at least one of said modules is hot swappable.

41. A hot swappable audio and data communications gateway apparatus comprising:
a housing having a front end and a back end;
an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel;
a first slot in said back end of said housing having a corresponding external access opening;
three additional slots in said back end of said housing, each of said additional slots having a corresponding external access opening adapted to receive a selected one of a plurality of function modules, wherein a full bi-directional CODEC module is inserted into one of said three additional slots, the remainder of the plurality of function modules selected from the group consisting of an ISDN terminal adapter, a T1 multiplexer, an E1 multiplexer, a V.35 digital interface module, and an X.21/RS422 digital interface module;
a control processor circuit card inserted into said first slot; and
a configuration software program stored on said control processor circuit card, said configuration program adapted to identify at least one of said modules inserted into one of said second, third, and fourth slots, and to provide a corresponding configuration menu having said configuration parameter option to said interface panel, and to receive said corresponding configuration parameter option setting from said interface panel;
wherein at least one of said modules is hot swappable.

42. A hot swappable audio and data communications gateway apparatus comprising:
a housing having a front end and a back end;
an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel;
a first slot in said back end of said housing having a corresponding external access opening;
three additional slots in said back end of said housing, each of said additional slots having a corresponding external access opening adapted to receive a selected one of a plurality of function modules, wherein an encoder module is inserted into one of said three additional slots, the remainder of the plurality of function modules selected from the group consisting of a decoder module, an ISDN terminal adapter, a T1 multiplexer, an E1 multiplexer, a V.35 digital interface module, and an X.21/RS422 digital interface module;
a control processor circuit card inserted into said first slot; and
a configuration software program stored on said control processor circuit card, said configuration program adapted to identify at least one of said modules inserted into one of said second, third, and fourth slots, and to provide a corresponding configuration menu having said configuration parameter option to said interface panel, and to receive said corresponding configuration parameter option setting from said interface panel;
wherein at least one of said modules is hot swappable.

43. A hot swappable audio and data communications gateway apparatus comprising:
a housing having a front end and a back end;
an integral interface panel located at said front end of said housing, said interface panel adapted to display a configuration parameter option to a user and to receive a corresponding configuration parameter option setting from the user, said interface panel containing thereon an input mechanism and a backlit alphanumeric LCD visual display panel;
a first slot in said back end of said housing having a corresponding external access opening;
three additional slots in said back end of said housing, each of said additional slots having a corresponding external access opening adapted to receive a selected one of a plurality of function modules, wherein a decoder module is inserted into one of said three additional slots, the remainder of the plurality of function modules selected from the group consisting of an encoder module, an ISDN terminal adapter, a T1 multiplexer, an E1 multiplexer, a V.35 digital interface module, and an X.21/RS422 digital interface module;
a control processor circuit card inserted into said first slot; and
a configuration software program stored on said control processor circuit card, said configuration program adapted to identify at least one of said modules inserted into one of said second, third, and fourth slots, and to provide a corresponding configuration menu having said configuration parameter option to said interface panel, and to receive said corresponding configuration parameter option setting from said interface panel;
wherein at least one of said modules is hot swappable.

44. A hot swappable audio and data communications gateway apparatus comprising:
a housing having a front end and a back end comprised of a steel chassis;
an integral interface panel located at said front end of said housing, said interface panel adapted to display a configuration parameter option to a user and to receive a corresponding configuration parameter option setting from the user, said interface panel containing thereon a circular navigation switch wheel, an alpha-numeric keypad, a plurality of programmable function keys, a backlit alphanumeric LCD visual display panel configured for 30 characters by 4 lines, a VU meter, a headphone output jack, a volume control, and an adjustable display contrast;
an international power supply;
two fans for cooling said apparatus;
a first slot in said back end of said housing having a corresponding external access opening;
three additional slots in said back end of said housing, each of said additional slots having a corresponding external access opening adapted to receive a selected one of a plurality of function modules selected from the group consisting of an encoder module, a decoder module, a full bi-directional CODEC module, an ISDN terminal adapter, a T1 multiplexer, an E1 multiplexer, a V.35 digital interface module, and an X.21/RS422 digital interface module, wherein at least one of said plurality of function modules is hot swappable through a port and into a bus;
a power cord connector socket in said back end of said housing;
a power switch in said back end of said housing;
a control processor circuit card insertable into said first slot;
an ethernet connectivity port contained on said control processor circuit card;
a configuration software program stored on said control processor circuit card, said configuration program adapted to identify at least one of said plurality of function modules inserted into one of said three additional slots, and to provide a corresponding configuration menu having said configuration parameter option to said interface panel, and to receive said corresponding configuration parameter option setting from said interface panel;
a first input in said back end of said module for inputting an input signal; and
a first output in said back end of said module for outputting an output signal, the output signal being related to the input signal according to said selected one of said plurality of function modules and said corresponding configuration parameter option setting.

45. The apparatus as claimed in claim 1, wherein said interface panel further comprises at least two VU meters.

46. The apparatus as claimed in claim 1, wherein said interface panel further comprises at least four VU meters.
